(19) United States
(12) Patent Application Publication
(10) Pub. No.: US 2005/0265594 A1
(43) Pub. Date: Dec. 1, 2005

(54) Board inspection apparatus and method

(75) Inventor: Yuji Mizuno, Kyoto (JP)

Correspondence Address: MCDERMOTT WILL & EMERY LLP, 600 13TH STREET, N.W., WASHINGTON, DC, 20005-3096, US

(73) Assignee: DAINIPPON SCREEN MFG. CO., LTD.

(21) Appl. No.: 11/118,481

(22) Filed: May 2, 2005

(30) Foreign Application Priority Data
May 25, 2004 (JP) 2004-154494

(51) Int. Cl. G06K 9/00

(52) U.S. Cl. 382/147

(57) ABSTRACT

First and second inspection stages 2 and 3 are rotatably configured and provided with four A-side inspection suction tables 22 and four B-side inspection suction tables 32. Distances between A- and B-side inspection suction tables 22 and 32 and their corresponding rotary shaft are changed by extension/contraction operations of air cylinders 23 and 33. A board S in a board supply section 7 is sucked and fixed onto an A-side inspection suction table 22, and passed to the second inspection stage 3 after an image of the A-side thereof is captured by an A-side inspection head 4. The board S is sucked and fixed onto the B-side inspection suction table 32, and ejected to a board receiving section 8 after an image of the B-side thereof is captured by a B-side inspection head 5. A board inspection apparatus 1 performs the above processes in parallel.

### BACKGROUND OF THE INVENTION

1. Field of the Invention

The present invention relates to a board inspection apparatus and method, and more particularly, a board inspection apparatus and method for visually inspecting opposite sides of a board to be inspected.

2. Related Art Statement

Conventionally, various types of visual inspection apparatuses have been developed for determining the quality of a board, e.g., a printed circuit board for mounting thereon electronic components such as semiconductor devices, by determining the quality of a pattern formed on the board based on image data obtained by capturing an image of the pattern of the board. Japanese Laid-Open Patent Publication No. 2000-196223 discloses an inspection apparatus which include a plurality of inspection stages for performing parallel processing therein with the aim of increasing temporal efficiency in a visual inspection and achieving a compact apparatus size.

Also, in some cases, opposite sides of a board (double-sided board) are required to be visually inspected, and therefore visual inspection apparatuses for efficiently performing a visual inspection have been developed. Japanese Laid-Open Patent Publication No. 2003-99758 discloses a visual inspection apparatus in which individual images of top and bottom sides of a double-sided board are captured from different coordinate positions, and the top and bottom sides are separately subjected to a visual inspection, thereby preventing mutual interference between a visual inspection of the top side and a visual inspection of the bottom side.

In the visual inspection apparatus disclosed in Japanese Laid-Open Patent Publication No. 2000-196223, however, it is necessary to perform the visual inspection for each side of the double-sided board. Accordingly, when inspecting the bottom side of the double-sided board after inspecting the topside, for example, it is necessary to turn over the board before inspecting the bottom side, leading to a reduction in temporal efficiency of the visual inspection.

Also, in the visual inspection apparatus disclosed in Japanese Laid-Open Patent Publication No. 2003-99758, relatively rigid and self-supporting materials are targeted for inspection, and fragile materials, which is not self-supportable, cannot be inspected. Note that it is conceivable that a fragile material can be inspected when it is supported by another material, but in such a case, at least part of the material is covered by the supporting material, and therefore opposite sides of the material to be inspected cannot be inspected in their entirety.

### SUMMARY OF THE INVENTION

Therefore, an object of the present invention is to provide a board inspection apparatus and method which allows opposite sides of a board to be inspected, thereby increasing temporal efficiency in inspection.

The present invention has the following features to attain the object mentioned above.

A first aspect of the present invention is directed to a board inspection apparatus for capturing, as an image, and inspecting opposite sides of a board. The board inspection apparatus includes a first inspection stage, a second inspection stage, a rotary drive section, an imaging section, a board supply section, and a board ejection section. The first inspection stage a first inspection stage includes a plurality of first board holding faces provided about a first rotary shaft, and the plurality of first board holding faces are each brought into contact with a first principal face of the board to hold the board. The second inspection stage is provided next to the first inspection stage, and includes a plurality of second board holding faces provided about a second rotary shaft, the plurality of second board holding faces each being brought into contact with a second principal face of the board to hold the board. The rotary drive section changes directions of the plurality of first board holding faces and the plurality of second board holding faces by turning the first inspection stage about the first rotary shaft and turning the second inspection stage about the second rotary shaft. The imaging section simultaneously captures images of principal faces of boards held by a parallel set consisting of a first board holding face and a second board holding face positioned in parallel therewith. The board supply section supplies a board to a first board holding face different from the first board holding face in the parallel set. The board ejection section ejects a board held by a board holding face different from the second board holding face in the parallel set.

In a second aspect based on the first aspect, the board inspection apparatus further includes a control section for controlling the plurality of first board holding faces or the plurality of second board holding faces so as to hold and release the board. The first inspection stage includes a first board holding face drive section for moving the plurality of first board holding faces to change their distances from the first rotary shaft. The second inspection stage includes a second board holding face drive section for moving the plurality of second board holding faces to change their distances from the second rotary shaft. The first board holding face drive section and the second board holding face drive section cause an opposing set consisting of a first board holding face and a second board holding face opposed thereto, to move away from the first rotary shaft and the second rotary shaft, respectively, such that a second principal face of a board held by the first board holding face in the opposing set is brought into contact with the second board holding face in the opposing set. The control section controls the opposing set of the first board holding face and the second board opposed thereto, such that a board held by the first board holding face in the opposing set is released therefrom, and held by the second board holding face in the opposing set.

In a third aspect based on the first aspect, the imaging section includes a first imaging device, a second imaging device, a supporting element, and a linear drive section. The first imaging device captures an image of a second principal face of a board held by the first board holding face in the parallel set. The second imaging device captures an image of a first principal face of a board held by the second board holding face in the parallel set. The supporting element supports the first imaging device and the second imaging device. The linear drive section moves the supporting element in a direction parallel to the parallel set consisting of the first board holding face and the second board holding face positioned in parallel therewith.

In a fourth aspect based on the first aspect, the first inspection stage has four first board holding faces provided in four directions around the first rotary shaft. The second inspection stage has four second board holding faces provided in four directions around the second rotary shaft.

In a fifth aspect based on the fourth aspect, the first rotary shaft and the second rotary shaft are horizontally positioned in parallel with each other. The rotary drive section turns the first inspection stage and the second inspection stage such that at least one of the four first board holding faces and at least one of the four second board holding faces are opposed to each other. The imaging section simultaneously captures images of principal faces of boards held by a parallel set consisting of a first board holding face and a second board holding face, which are positioned in parallel with each other on top sides of the first inspection stage and the second inspection stage, respectively. The board supply section supplies a board to a first board holding face positioned on a bottom side of the first inspection stage. The board ejection section ejects a board held by a second board holding face positioned on a bottom side of the second inspection stage. A board is passed from a first board holding face to a second board holding face opposed thereto.

In a sixth aspect based on the fifth aspect, the board inspection apparatus further includes a control section for controlling the four first board holding faces or the four second board holding faces so as to hold and release the board. The first inspection stage includes a first board holding face drive section for moving the four first board holding faces so as to change their distances from the first rotary shaft. The second inspection stage includes a second board holding face drive section for moving the four second board holding faces so as to change their distance from the second rotary shaft. The first board holding face drive section and the second board holding face drive section cause an opposing set consisting of a first board holding face and a second board holding face opposed thereto, to move away from the first rotary shaft and the second rotary shaft, respectively, such that a second principal face of a board held by the first board holding face in the opposing set is brought into contact with the second board holding face in the opposing set. The control section controls the opposing set of the first board holding face and the second board holding face opposed thereto, such that a board held by the first board holding face in the opposing set is released from the first board holding face in the opposing set, and passed to and held by the second board holding face in the opposing set.

In a seventh aspect based on the fifth aspect, the board inspection apparatus further includes contact portions fixed in an imaging space of the imaging section. The first inspection stage includes a first board holding face drive section for moving the four first board holding faces to change their distances from the first rotary shaft. The second inspection stage includes a second board holding face drive section for moving the four second board holding faces to change their distances from the second rotary shaft. The first board holding face drive section and the second board holding face drive section cause a parallel set consisting of a first board holding face and a second board holding face positioned in parallel therewith, to move away from the first rotary shaft and the second rotary shaft, respectively, such that the parallel set of the first board holding face and the second board holding face positioned in parallel therewith are positioned so as to be in contact with their respective contact portions.

In an eighth aspect based on the fifth aspect, the board ejection section includes a plurality of board cases, and a turn table. The plurality of board cases receive an ejected board. The turn table has a rotary flat face turning about a predetermined perpendicular axis, the rotary flat face having the plurality of board cases mounted thereon. The board ejection section turns the turn table such that one of the plurality of board cases is positioned immediately below the second board holding face positioned on the bottom side of the second inspection stage in accordance with the board held by the second board holding face positioned on the bottom side of the second inspection stage.

A ninth aspect of the present invention is directed to a board inspection method for capturing, as an image, and inspecting opposite sides of a board. The board inspection method includes a board supply step, an imaging step, a board ejection step, and a turning step. The board supply step supplies the board to a first inspection stage including a plurality of first board holding faces provided about a first rotary shaft, at least one of the plurality of first board holding faces being brought into contact with a first principal face of the board to hold the board. The imaging step simultaneously captures images of principal faces of boards held by a parallel set consisting of a first board holding face and a second board holding face positioned in parallel therewith. The board ejection step ejects a board held by at least one of a plurality of second board holding faces from a second inspection stage provided next to the first inspection stage and including the plurality of second board holding faces provided about a second rotary shaft. The turning step changes directions of the plurality of first board holding faces and the plurality of second board holding faces by turning the first inspection stage about the first rotary shaft and turning the second inspection stage about the second rotary shaft.

In a tenth step based on the ninth step, the board inspection method further includes a board passing step. The board passing step passes a board by a first board holding face to a second board holding face opposed to the first board holding face, so as to bring the second board holding face into contact with a second principal face of the board, and thereby to cause the second board holding face to hold the board. The board supply step, the imaging step, the board ejection step, and the board passing step are simultaneously performed.

According to the first aspect, it is possible to perform different processes on boards held by the plurality board holding faces, and the processes can be performed in parallel. Accordingly, a series of processes for inspecting opposite sides of boards are performed in parallel, and therefore, it is possible to inspect in parallel the opposite sides of the boards, while ensuring efficient throughput. Also, even if the boards are composed of a fragile material, a principal face of each board is supported by a board holding face in contact therewith, and therefore, the board can be reliably secured. Further, the board is not covered by any element except in a portion in contact with the board holding face, and therefore, any portion of the board can be captured as an image by an imaging device.

According to the second aspect, a board held by a first board holding face in contact with a first principal face of the board is passed to a second board holding face by bringing a second principal face of the board into contact with the second board holding face, and therefore, it is possible to eliminate a complex mechanism for turning over the board, making it easy to capture images of the opposite faces of the board.

According to the third aspect, the imaging section moves in parallel with first and second board holding faces positioned in parallel with each other, and therefore, an imaging range of the imaging section is increased. Also, one supporting element has mounted thereon an imaging device for a first principal face and an imaging device for a second principal face, and therefore it is possible to use an integrated drive source.

According to the fourth aspect, board holding faces provided in the first inspection stage and the second inspection stage are each positioned to face a side face of a rectangular parallelepiped having its center on a rotary shaft, and therefore, it is easy to design and produce the board inspection apparatus itself.

According to the fifth aspect, boards are supplied/ejected from board holding faces positioned on bottom sides. Therefore, an uninspected board placed on the top of a pile of uninspected boards can be sequentially supplied, and inspected boards can be sequentially piled. Also, images of principal faces of boards held by board holding faces positioned in parallel with each other on top sides are simultaneously captured, and therefore, it is easy to control focusing and scanning operations of the imaging section. Further, a board is passed from a board holding face to another board holding face opposed thereto, and therefore, it is possible to switch the principal face that is to be in contact with a board holding face without turning over the board.

According to the sixth aspect, a board held by a first board holding face in contact with a first principal face of the board is passed to a second board holding face by bringing a second principal face of the board into contact with the second board holding face, and therefore, it is possible to eliminate a complex mechanism for turning over the board, making it easy to capture images of the opposite faces of the board.

According to the seventh aspect, a board holding face, which holds a board targeted for imaging, is moved to a position where the board holding face is in contact with contact portions fixed in an imaging space, and therefore, it is possible to place the board targeted for imaging in a position where the imaging section can reliably capture an image of the board targeted for imaging.

According to the eighth aspect, a plurality of board cases for receiving inspected boards are provided, and can be switched between them in accordance with the type of a board to be ejected. Thus, it is possible to classify boards into different types in accordance with their inspection results, and to eject different types of boards to different destinations.

Also, the board inspection method of the present invention achieves effects similar to the above-described effects achieved by the board inspection apparatus of the present invention.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a front view illustrating a schematic structure of a board inspection apparatus 1 according to an embodiment of the present invention;

FIG. 2 is a top view illustrating a schematic structure of the board inspection apparatus shown in FIG. 1;

FIG. 3 is a front view illustrating a schematic structure of the board inspection apparatus 1 shown in FIG. 1 with its air cylinders 23 and 33 in an extended state;

FIG. 4 is an internal side view illustrating a schematic structure of an air pressure mechanism of the board inspection apparatus 1 shown in FIG. 1;

FIG. 5 is a rear view illustrating a structure of a mechanism for rotationally driving a rotary element of the board inspection apparatus 1 shown in FIG. 1;

FIG. 6 is a flowchart illustrating an operation performed by the board inspection apparatus 1 shown in FIG. 1 for inspecting boards S;

FIGS. 7A-7C are schematic views illustrating the first phase of an operation of the board inspection apparatus 1 shown in FIG. 1 repeating the procedure of the flowchart shown in FIG. 6;

FIGS. 8A-8C are schematic views illustrating the second phase of the operation of the board inspection apparatus 1 shown in FIG. 1 repeating the procedure of the flowchart shown in FIG. 6;

FIGS. 9A-9C are schematic views illustrating the third phase of the operation of the board inspection apparatus 1 shown in FIG. 1 repeating the procedure of the flowchart shown in FIG. 6;

FIGS. 10A-10C are schematic views illustrating the fourth phase of the operation of the board inspection apparatus 1 shown in FIG. 1 repeating the procedure of the flowchart shown in FIG. 6;

FIGS. 11A-11C are schematic views illustrating the fifth phase of the operation of the board inspection apparatus 1 shown in FIG. 1 repeating the procedure of the flowchart shown in FIG. 6;

FIGS. 12A-12C are schematic views illustrating the sixth phase of the operation of the board inspection apparatus 1 shown in FIG. 1 repeating the procedure of the flowchart shown in FIG. 6;

FIGS. 13A-13C are schematic views illustrating the seventh phase of the operation of the board inspection apparatus 1 shown in FIG. 1 repeating the procedure of the flowchart shown in FIG. 6;

FIGS. 14A and 14B are illustrations of an example where a first inspection stage 200 and a second inspection stage 300 each include eight inspection suction tables; and

FIGS. 15A-15D are illustrations of an example where a first inspection stage 250 and a second inspection stage 350 each include two inspection suction tables.

### DESCRIPTION OF THE PREFERRED EMBODIMENTS

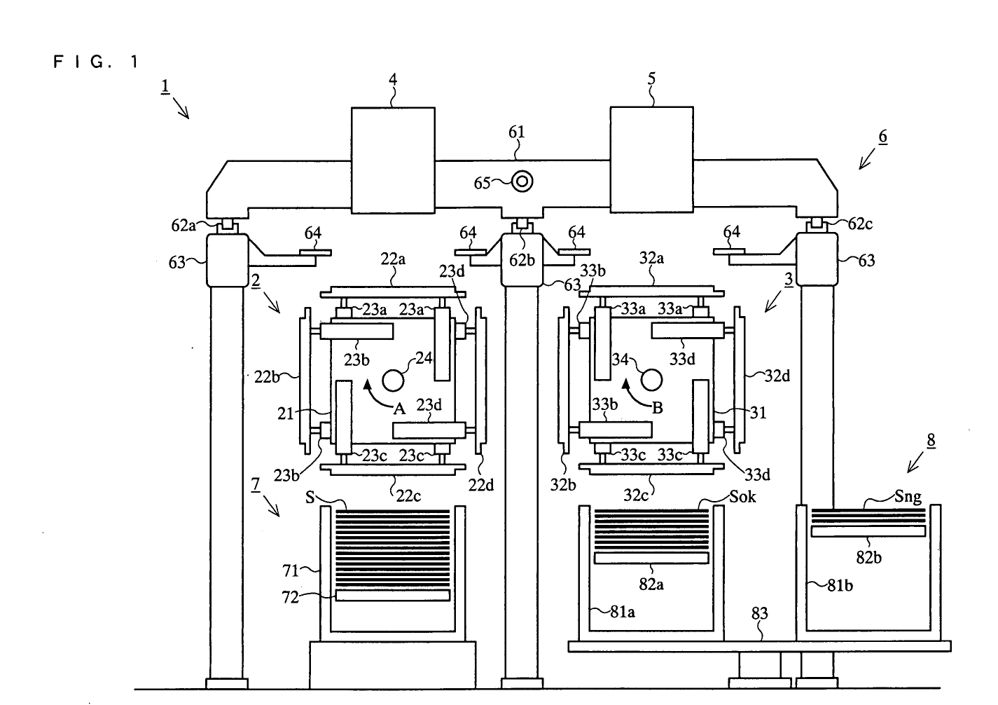

Referring to FIGS. 1-5, a board inspection apparatus according to an embodiment of the present invention is described.

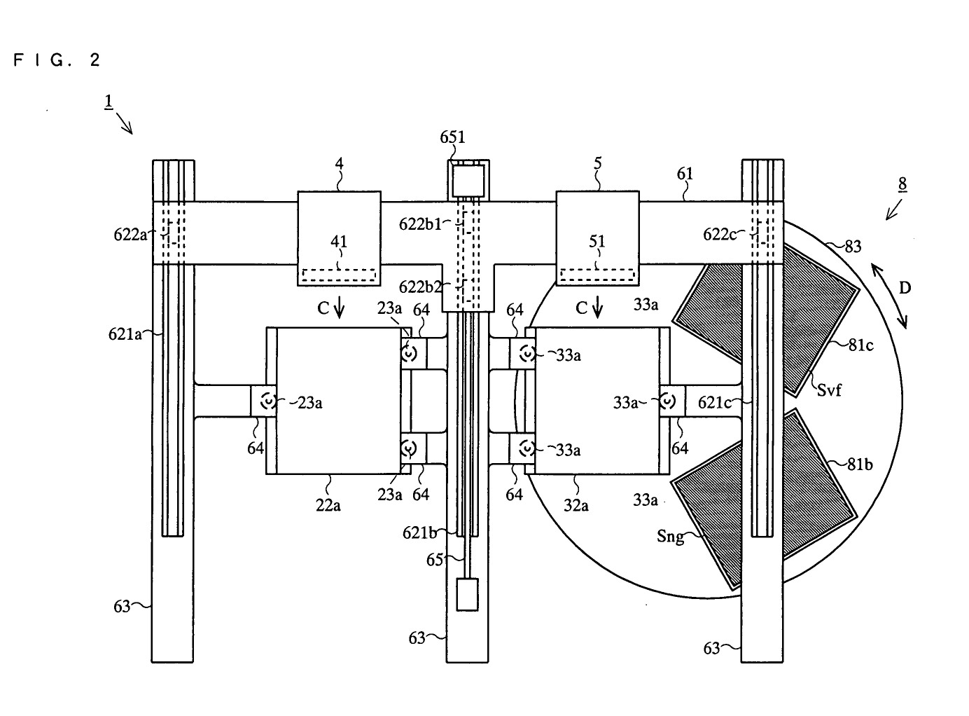

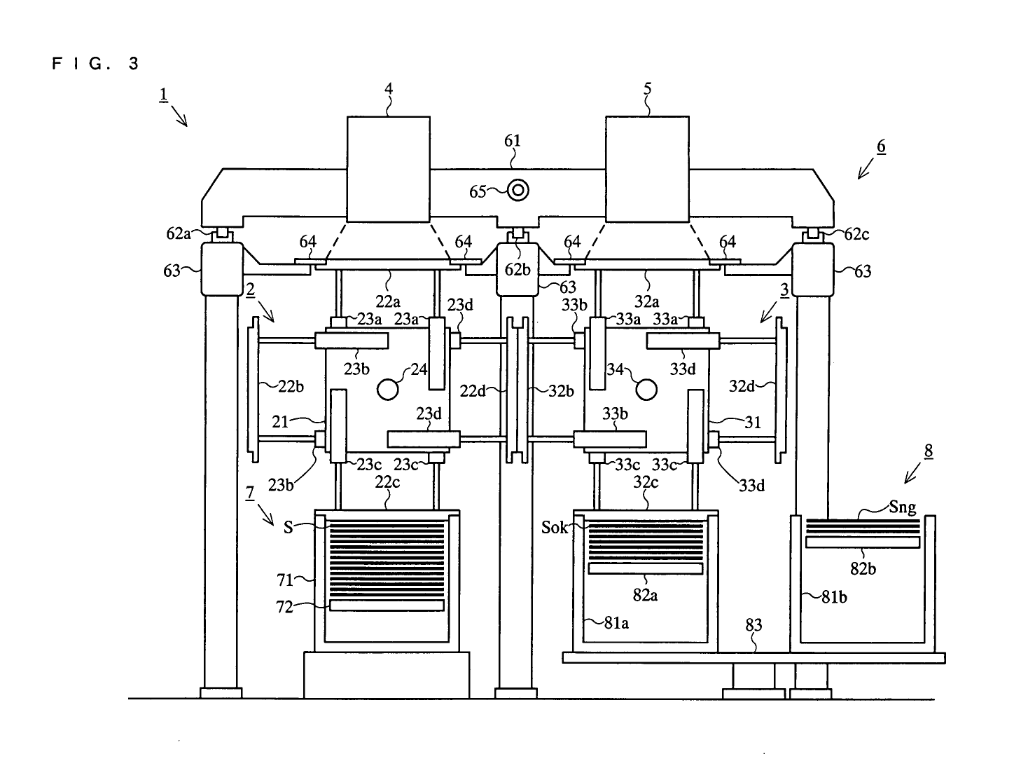

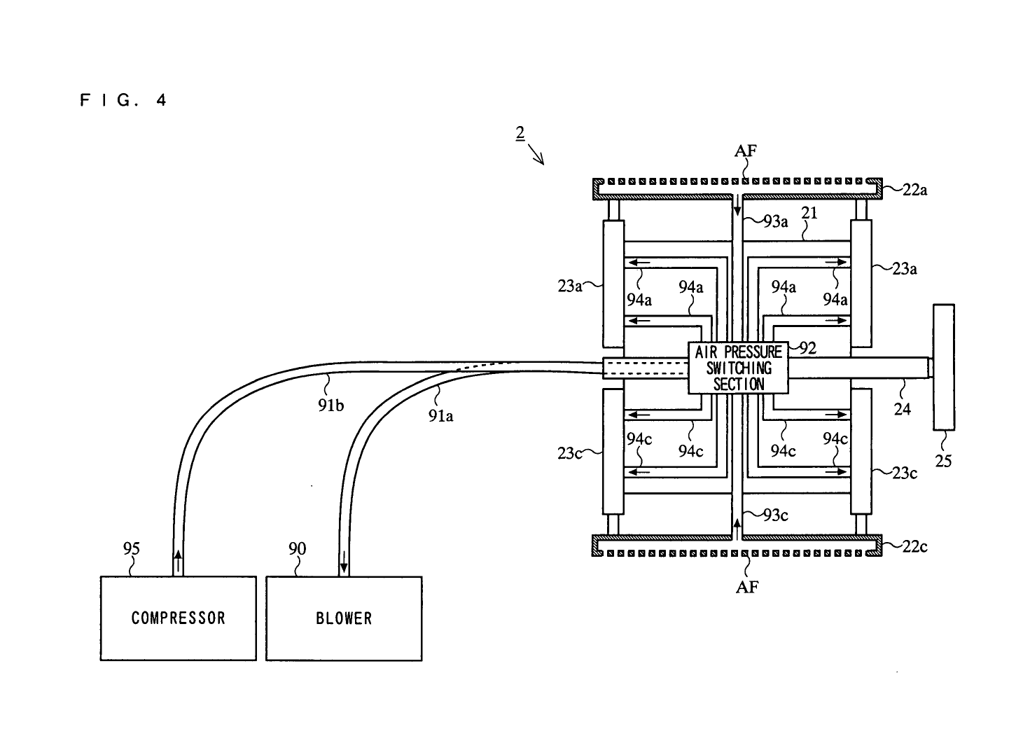

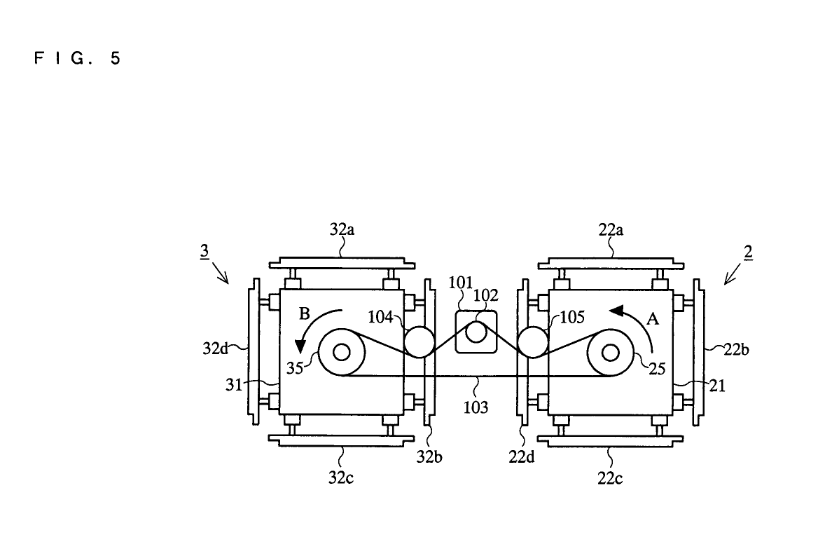

FIG. 1 is a front view illustrating a schematic structure of the board inspection apparatus. FIG. 2 is a top view illustrating a schematic structure of the board inspection apparatus. FIG. 3 is a front view illustrating a schematic structure of the board inspection apparatus with its air cylinders in an extended state. FIG. 4 is an internal side view illustrating a schematic structure of an air pressure mechanism of the board inspection apparatus. FIG. 5 is a rear view illustrating a structure of a mechanism for rotationally driving a rotary element of the board inspection apparatus. For clarification of positional relationships between elements, FIGS. 1-5 do not illustrate all elements of a board inspection apparatus 1.

In FIG. 1, the board inspection apparatus 1 includes a first inspection stage 2, a second inspection stage 3, an A-side inspection head 4, a B-side inspection head 5, a frame 6, a board supply section 7, a board receiving section 8, and a control section (not shown). Here, the board inspection apparatus 1 inspects boards, such as printed circuit boards, for mounting thereon electronic components, such as semiconductor devices, and the boards to be inspected are double-sided boards which requires visual inspection on opposite side thereof. In the following descriptions, one of two principal faces of a board to be inspected is referred to as an “A-side”, and the other is referred to as a “B-side”.

The first inspection stage 2 includes a first rotary element 21, A-side inspection suction tables 22a, 22b, 22c, and 22d, air cylinders 23a, 23b, 23c, and 23d, and a first rotary shaft 24. The first rotary element 21 has substantially a rectangular parallelepiped shape, and is rotatable about the first rotary shaft 24 in a direction indicated by “A” in FIG. 1. Four side faces of the first rotary element 21 that are parallel to the first rotary shaft 24 are provided with a corresponding one of four A-side inspection suction tables 22a-22d with their respective air cylinders 23a-23d. The first rotary shaft 24 is directed perpendicular to the sheet of FIG. 1. The A-side inspection suction table 22a is provided on three air cylinders 23a overlying the first rotary shaft 24 (in FIG. 1, only two air cylinders 23a are shown). The A-side inspection suction table 22b is provided on three air cylinders 23b lying at the left side of the first rotary shaft 24 (in FIG. 1, only two air cylinders 23b are shown). The A-side inspection suction table 22c is provided on three air cylinders 23c underlying the first rotary shaft 24 (in FIG. 1, only two air cylinders 23c are shown), so as to be in parallel with the A-side inspection suction table 22a. The A-side inspection suction table 22d is provided on three air cylinders 23d lying at the right side of the first rotary shaft 24 (in FIG. 1, only two air cylinders 23d are shown), so as to be in parallel with the A-side inspection suction table 22b.

The second inspection stage 3 is provided next to the first inspection stage 2. The second inspection stage 3 includes a second rotary element 31, B-side inspection suction tables 32a, 32b, 32c, and 32d, air cylinders 33a, 33b, 33c, and 33d, and a second rotary shaft 34. Similar to the first rotary element 21, the second rotary element 31 has substantially a rectangular parallelepiped shape, and is rotatable about the second rotary shaft 34, which is parallel to the first rotary shaft 24, in a direction indicated by “B” in FIG. 1. Four side faces of the second rotary element 31 that are parallel to the second rotary shaft 34 are provided with a corresponding one of four B-side inspection suction tables 32a-32d with their respective air cylinders 33a-33d. The second rotary shaft 34 is directed perpendicular to the sheet of FIG. 1. The B-side inspection suction table 32a is provided on three air cylinders 33a overlying the second rotary shaft 34 (in FIG. 1, only two air cylinders 33a are shown). The B-side inspection suction table 32b is provided on three air cylinders 33b lying at the left side of the first rotary shaft 34 (in FIG. 1, only two air cylinders 33b are shown), so as to be opposed to the A-side inspection suction table 22d. The B-side inspection suction table 32c is provided on three air cylinders 33c underlying the second rotary shaft 34 (in FIG. 1, only two air cylinders 33c are shown), so as to be in parallel with the B-side inspection suction table 32a. The B-side inspection suction table 32d is provided on three air cylinders 33d lying at the right side of the second rotary shaft 34 (in FIG. 1, only two air cylinders 33d are shown), so as to be in parallel with the B-side inspection suction table 32b.

As shown in FIGS. 1 and 2, the frame 6 is substantially composed of an inspection head support 61, three linear motion bearings 62a, 62b, and 62c, a body base 63, contact elements 64, and a ball screw 65. The body base 63 is fixed by supporting columns to a plane above the first inspection stage 2 and the second inspection stage 3. The linear motion bearings 62a-62c are each composed of, for example, a combination of a rail and a slide block, but they can be composed of various combinations of a shaft and a bearing or sleeve, a guide rail and a guide, and so on, other than the combination of a rail and a slide block. The three linear motion bearings 62a-62c include the irrespective rails 621a, 621b, and 621c and slide blocks 622a, 622b1, 622b2, and 622c, and the rails 621a-621c are fixed on the top side of the body base 63 (in FIG. 2, the rails 621a-621c and the slide blocks 622a-622c, which are provided on the bottom of the inspection head support 61, are indicated by broken lines). The rails 621a-621c are fixed at predetermined intervals so as to be in parallel with each other, such that the rail 621b is positioned between the rails 621a and 621c. The first inspection stage 2 is positioned in a space below and between the rails 621a and 621b, and the second inspection stage 3 is positioned in a space below and between the rails 621b and 621c. Also, the body base 63 is provided with the ball screw 65 which is situated in a space above the rail 621b so as to be in parallel with the rail 621b, and rotationally driven by a linear motor 651. Here, driving of the linear motor 651 is controlled by the above-mentioned control section. Note that in FIGS. 1 and 2, the body base 63 for supporting the rails 621a-621c is illustrated as if a plurality of body bases 63 are separately provided, in order to clarify the relationship with other elements, and the separate body bases 63 are fixed and connected together so as to form openings at least in spaces above the first inspection stage 2 and the second inspection stage 3. The contact portions 64 are positioned on the same plane (for example, three contact portions are provided for each of the openings). The contact portions 64 protrude into the openings, and are fixed to the body base 63.

The inspection head support 61 is extended from the rails 621a to 621c fixed on the top face of the body base 63. The slide blocks 622a, 622b1, 622b2, and 622c are provided below the inspection head support 61. The slide block 622a is slidably engaged with the rail 621a, the slide blocks 622b1 and 622b2 are slidably engaged with the rail 621b, and the slide block 622c is slidably engaged with the rail 621c. Also, the inspection head support 61 is screwed with the ball screw 65 above the slide blocks 622b1 and 622b2, such that when the linear motor 651 starts, the ball screw 65 is rotated to cause the inspection head support 61 to move along the body base 63 in a direction along which the rails 621a-621c are provided in parallel with each other (direction indicated by “C” in FIG. 2).

Also, the A-side inspection head 4 and the B-side inspection head 5 are disposed on the inspection head support 61. The A-side inspection head 4 and the B-side inspection head 5 each include an imaging device (not shown), e.g., a CCD camera, which captures an image of a space below the inspection head support 61 through a slit 41 or 51 which is opened downward (as indicated by broken lines in FIG. 2). The A-side inspection head 4 is disposed on the inspection head support 61 in an area between the slide block 622a and the slide blocks 622b1 and 622b2. Specifically, as will become apparent from later descriptions, when one of the A-side inspection suction tables 22a-22d of the first inspection stage 2 is placed so as to be in contact with the contact portions 64, the inspection head support 61 is moved in the “C” direction shown in FIG. 2, so that the A-side inspection head 4 is placed where the imaging device of the A-side inspection head 4 is able to capture an image of a board S sucked by the A-side inspection suction table. Also, the B-side inspection head 5 is disposed on the inspection head support 61 in an area between the slide blocks 622b1 and 622b2 and the slide block 622c. Specifically, when one of the B-side inspection suction tables 32a-32d of the second inspection stage 3 is placed so as to be in contact with the contact portions 64, the inspection head support 61 is moved in the “C” direction shown in FIG. 2, so that the B-side inspection head 5 is placed where the imaging device of the B-side inspection head 5 is able to capture an image of a board S sucked by the B-side inspection suction table.

The board supply section 7 is placed in a space immediately below the first inspection stage 2. The board supply section 7 includes a board case 71, which has an opening facing up, and a lifting table 72. The lifting table 72 is provided within the board case 71, and boards S before inspection by the board inspection apparatus 1 are piled on the lifting table 72 within the board case 71. The lifting table 72 moves up and down such that a board S on the top of the pile of boards S is always placed at the same level in a vertical direction. Note that the uninspected boards S supplied to the board supply section 7 are piled within the board case 71, such that one principal face thereof, i.e., A-side, faces down. Also, as will become apparent from later descriptions, when one of the A-side inspection suction tables 22a-22d of the first inspection stage 2 moves down, outer edge portions of the A-side inspection suction table are brought into contact with top edges of the board case 71, and a suction face of the A-side inspection suction table is positioned in the opening of the board case 71.

The board receiving section 8 includes three board cases 81a, 81b, and 81c, three lifting tables 82a, 82b, and 82c, and a turn table 83. The lifting tables 82a-82c are provided within the board cases 81a-81c, respectively, and boards S inspected by the board inspection apparatus 1 are piled on the lifting tables 82a-82c within the board cases 81a-81c. The lifting tables 82a-82c moves up and down such that a board S on the top of the pile of boards S is always placed at the same level in a vertical direction. Specifically, in the board cases 81a-81c, boards S are piled in accordance with results of inspection by the board inspection apparatus 1. In the board case 81a, boards Sok having passed an inspection by the board inspection apparatus 1 with respect to both the A- and B-sides are piled. In the board case 81b, boards Snk having failed an inspection by the board inspection apparatus 1 with respect to the A-side and/or the B-side are piled. In the board case 81c, boards Svf which require a reinspection by the board inspection apparatus 1 with respect to the A-side and/or the B-side are piled. These board cases 81a-81c are placed on a rotary flat surface of the turn table 83. The turn table 83 is controlled by the control section with respect to its turn and stop positions in a direction indicated by “D” in FIG. 2, such that any one of the board cases 81a-81c is placed in a space immediately below the second inspection stage 3. Note that in the board receiving section 8, the inspected boards Sok, Sng, and Svf are piled with their A-sides facing up within the board cases 81a-81c. Also, as will become apparent from later descriptions, when one of the B-side inspection suction tables 32a-32d of the second inspection stage 3 moves down, outer edge portions of the B-side inspection suction table are brought into contact with top edges of any one of the board cases 81a-81c placed immediately below the B-side inspection suction table, and a suction face of the B-side inspection suction table is placed in an opening of the board case placed immediately below the B-side inspection suction table.

Next, referring to FIGS. 1-3, an extension/contraction operation of the air cylinders 23a-23d and 33a-33d included in the first inspection stage 2 and the second inspection stage 3, respectively, is described.

As described above, the first rotary element 21 is provided with the air cylinders 23a-23d for supporting the A-side inspection suction tables 22a-22d, respectively. The air cylinders 23a-23d are controlled by the control section so as to perform an extension/contraction operation, and the extension/contraction operation changes the distance between their respective A-side inspection suction tables 22a-22d and the first rotary shaft 24. In FIG. 1, the air cylinders 23a-23d are in a contracted state, and the A-side inspection suction tables 22a-22d are each placed in the vicinity of a side face of the first rotary element 21. Also, in FIG. 3, the air cylinders 23a-23d are in an extended state, and the A-side inspection suction tables 22a-22d are placed away from the first rotary element 21.

As shown in FIGS. 2 and 3, when the air cylinders 23a are extended, the A-side inspection suction table 22a overlying the first rotary shaft 24 is placed where top faces of outer edge portions of the A-side inspection suction table 22a (i.e., faces on a side facing away from the first rotary shaft 24) are in contact with the contact portions 64. Hereinafter, the position of any A-side inspection suction table placed in contact with the contact portions 64 is referred to as an “A-side inspection position”. In the present embodiment, in order to reliably place the A-side inspection suction table 22a in the A-side inspection position as shown in FIG. 2, areas (three in total) where the contact portions 64 are fixed overlap with areas (three in total) where the air cylinders 23a support the A-side inspection suction table 22a.

Also, as shown in FIG. 3, when the air cylinders 23c are extended, bottom faces of outer edge portions of the A-side inspection suction table 22c underlying the first rotary shaft 24 (i.e., faces on a side facing away from the first rotary shaft 24) are brought into contact with top edges of the board case 71 of the board supply section 7, and a suction face of the A-side inspection suction table 22c is placed in the opening of the board case 71. Hereinafter, the position of any A-side inspection suction table placed in the opening of the board case 71 is referred to as a “board supply position”.

Further, as shown in FIG. 3, when the air cylinders 23d are extended, a suction face of the A-side inspection suction table 22d lying at the right side of the first rotary shaft 24 is brought into contact with a suction face of the B-side inspection suction table 32b with its air cylinders 33b extended. Hereinafter, the position where the suction face of any A-side inspection suction table is in contact with the suction face of any B-side inspection suction table is referred to as a “board passing position”.

Also, the second rotary element 31 is provided with the air cylinders 33a-33d for supporting the B-side inspection suction tables 32a-32d, respectively. The air cylinders 33a-33d are controlled by the control section so as to perform an extension/contraction operation, and the extension/contraction operation changes the distance between their respective B-side inspection suction tables 32a-32d and the second rotary shaft 34. In FIG. 1, the air cylinders 33a-33d are in a contracted state, and the B-side inspection suction tables 32a-32d are each placed in the vicinity of a side face of the second rotary element 31. Also, in FIG. 3, the air cylinders 33a-33d are in an extended state, and the B-side inspection suction tables 32a-32d are placed away from the second rotary element 31.

As shown in FIGS. 2 and 3, when the air cylinders 33a are extended, the B-side inspection suction table 32a overlying the second rotary shaft 34 is placed where top faces of outer edge portions of the B-side inspection suction table 32a (i.e., faces on a side facing away from the second rotary shaft 34) are in contact with the contact portions 64. Hereinafter, the position of any B-side inspection suction table placed in contact with the contact portions 64 is referred to as a “B-side inspection position”. In the present embodiment, in order to reliably place the B-side inspection suction table 32a in the B-side inspection position as shown in FIG. 2, areas (three in total) where the contact portions 64 are fixed overlap with areas (three in total) where the air cylinders 33a support the A-side inspection suction table 32a.

Also, as shown in FIG. 3, when the air cylinders 33c are extended, bottom faces of outer edge portions of the B-side inspection suction table 32c underlying the second rotary shaft 34 (i.e., faces on a side facing away from the second rotary shaft 34) are brought into contact with top edges of any one of the board cases 81a-81c of the board receiving section 8, and a suction face of the B-side inspection suction table 32c is placed in the opening of that board case. Hereinafter, the position of any B-side inspection suction table placed in the opening of any board case is referred to as a “board ejection position”.

Further, as shown in FIG. 3, when the air cylinders 33b are extended, a suction face of the B-side inspection suction table 32b lying at the left side of the second rotary shaft 34 is brought into contact with a suction face of the A-side inspection suction table 22d with its air cylinders 23d extended. Hereinafter, the position where the suction face of any B-side inspection suction table is in contact with the suction face of any A-side inspection suction table is referred to as a “board passing position”.

Next, referring to FIG. 4, an air pressure mechanism of the board inspection apparatus 1 is described. Although FIG. 4 illustrates only an air pressure mechanism of the first inspection stage 2, an air pressure mechanism of the second inspection stage 3 is similarly configured. Hereinbelow, the air pressure mechanism of the first inspection stage 2 is representatively described. For simplified illustration of the air pressure mechanism of the first inspection stage 2, FIG. 4 illustrates only portions of the first inspection stage 2, and also illustrates the A-side inspection suction tables 22a and 22c in cross section.

In FIG. 4, the air pressure mechanism of the board inspection apparatus 1 includes a blower 90, a compressor 95, a main pipe 91a, a main pipe 91b, an air pressure switching section 92, suction pipes 93a and 93c, and cylinder pipes 94a and 94c. The first rotary shaft 24 supports the air pressure switching section 92 in the first rotary element 21. The air pressure switching section 92 includes a plurality of switching valves controlled by the control section with respect to their open/close operations, and the first rotary shaft 24 includes a hollow path passing from one end of the shaft to each of the switching valves (as indicated by broken lines in FIG. 4). Also, the other end of the first rotary shaft 24 has a timing pulley 25 fixed thereon. The main pipe 91a passes through the hollow path in the first rotary shaft 24 to connect the blower 90 with the air pressure switching section 92, such that air pressure generated by the blower 90 is supplied through the air pressure control section 92 to the A-side inspection suction tables 22a-22d. Similarly, the main pipe 91b passes through the hollow path in the first rotary shaft 24 to connect the compressor 95 with the air pressure switching section 92, such that air pressure generated by the compressor 95 is supplied through the air pressure control section 92 to the air cylinders 23a-23d.

The A-side inspection suction tables 22a-22d each have a suction face AF with a plurality of suction holes formed therein (in FIG. 4, only the A-side inspection suction tables 22a and 22c are shown). Also, connected between the A-side inspection suction tables 22a-22d and switching valves of the air pressure switching section 92 are suction pipes 93a-93d which are extendable/contractible in accordance with an extension/contraction operation of their respective air cylinders 23a-23d (in FIG. 4, only the suction pipes 93a and 93c are shown). Here, the suction pipes 93a-93d are connected to their respective switching valves. Also, air pressure (negative pressure) to be supplied from the suction pipes 93a-93d to the A-side inspection suction tables 22a-22d is released from the suction holes formed in the A-side inspection suction tables 22a-22d. Specifically, when negative pressure is supplied through the suction pipes 93a-93d to the A-side inspection suction tables 22a-22d under the control of the control section, negative pressure is generated in each of the suction holes, and therefore the suction faces AF can be used for vacuum suction.

Also, connected between the air cylinders 23a-23d and switching valves of the air pressure switching section 92 are the cylinder pipes 94a-94d (in FIG. 4, only the cylinder pipes 94a and 94c are shown). Air pressure (positive pressure) is supplied from the compressor 95 to the cylinder pipes 94a-94d under the control of the control section, thereby allowing the air cylinders 23a-23d to perform the extension/contraction operation. The air pressure mechanism of the second inspection stage 3 is configured in the same manner as that of the first inspection stage 2, and therefore the detailed description thereof is omitted herein. Note that a timing pulley 35 is fixed at one end of the second rotary shaft 34 of the second inspection stage 3. Although the present embodiment illustrates an example where the air pressure switching section 92 switches between two air pressure systems, i.e., the blower 90 and the compressor 95, each of the two air pressure systems may have an individual switching section.

Next, referring to FIG. 5, a mechanism for rotationally driving the first rotary element 21 and the second rotary element 31 in the board inspection apparatus 1 is described. FIG. 5 is a rear view illustrating a portion of the board inspection apparatus 1. It should be noted that in FIG. 5, the positional relationship between the first inspection stage 2 and the second inspection stage 3 shown in FIGS. 1 and 3 is horizontally reversed, and their rotation directions are also reversed from those shown in FIG. 1.

In FIG. 5, the mechanism for rotationally driving the first rotary element 21 and the second rotary element 31 includes a rotary drive motor 101, a timing belt 103, and tension pulleys 104 and 105. The rotary drive motor 101 has a rotary shaft with a pulley 102 fixed thereon, and the rotary drive motor 101 rotationally drives the pulley 102 by a predetermined rotation angle under the control of the control section. The timing belt 103 is rotatable around the pulley 102 and the timing pulleys 25 and 35 via the tension pulleys 104 and 105. The tension pulleys 104 and 105 control the tension of the timing belt 103. Drive power of the rotary drive motor 101 causes the timing belt 103 to synchronously rotate the timing pulleys 25 and 35 by the same rotation angle. The first rotary shaft 24 and the second rotary shaft 34, which respectively have the timing pulleys 25 and 35 fixed thereon, are also rotated, and the first rotary element 21 and the second rotary element 31 are rotated in the directions “A” and “B”, respectively, as indicated in FIG. 5, in accordance with the rotation of the first rotary shaft 24 and the second rotary shaft 34. Note that in the present embodiment, the first rotary element 21 and the second rotary element 31 are rotated in the directions “A” and “B”, respectively, in units of 90 degrees, in accordance with a rotation instruction given by the control section.

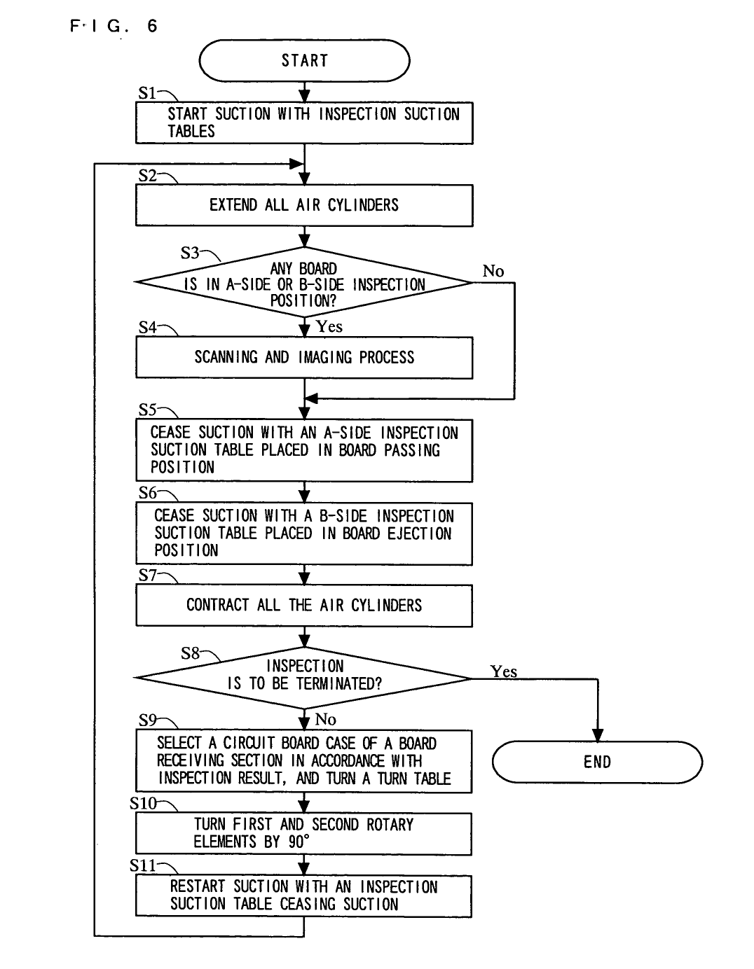

Next, referring to FIGS. 6 through 13C, operations of the board inspection apparatus 1 are described. FIG. 6 is a flowchart illustrating an operation performed by the board inspection apparatus 1 for inspecting boards S.

In FIG. 6, the control section of the board inspection apparatus 1 starts suction with all of the A-side inspection suction tables 22a-22d and the B-side inspection suction tables 32a-32d (step S1). Specifically, the control section controls open/close operations of switching valves of an air pressure control section (see FIG. 4) provided in each of the first inspection stage 2 and the second inspection stage 3, so as to supply negative pressure to the A-side inspection suction tables 22a-22d and the B-side inspection suction tables 32a-32d.

Next, the control section of the board inspection apparatus 1 supplies positive pressure from the compressor 95 to all of the air cylinders 23a-23d and 33a-33d such that they are moved in an extension direction (step S2; the state as shown in FIG. 3). With this operation, any three out of the four A-side inspection suction tables 22a-22d are placed in the A-side inspection position, the board supply position, and the board passing position, respectively. Here, when boards S are piled within the board supply section 7, a principal face (specifically, B-side) of a board S on the top of the pile of boards S is vacuum-sucked and secured onto a suction face of an A-side inspection suction table placed in the board supply position. In the example illustrated in FIG. 3, the A-side inspection suction table 22a is placed in the A-side inspection position, the A-side inspection suction table 22c is placed in the board supply position, and the A-side inspection suction table 22d is placed in the board passing position. Also, with the operation at step S2, any three out of the four B-side inspection suction tables 32a-32d are placed in the B-side inspection position, the board ejection position, and the board passing position, respectively. In the example of FIG. 3, the B-side inspection suction table 32a is placed in the B-side inspection position, the B-side inspection suction table 32c is placed in the board ejection position, and the B-side inspection suction table 32b is placed in the board passing position so as to be in contact with the A-side inspection suction table 22d.

Next, the control section of the board inspection apparatus 1 determines whether any board S is sucked and secured either on a suction face of an A-side inspection suction table placed in the A-side inspection position or on a suction face of a B-side inspection suction table placed in the B-side inspection position (step S3). In this determination, for example, an optical sensor (not shown) may directly detect a board, or a vacuum sensor (not shown) provided in an air pressure circuit may detect whether any board is sucked. If the control section determines that any board S is sucked and secured on either one of the suction faces, the control proceeds to step S4, and if it is determined that no board S is sucked and secured on the suction faces, the control proceeds to step S5.

At step S4, the control section of the board inspection apparatus 1 controls the imaging devices of the A-side inspection head 4 and the B-side inspection head 5 so as to capture images of principal faces of boards S sucked and secured on inspection suction tables placed in the A-side inspection position and the B-side inspection position, respectively, and the control proceeds to step S5. Specifically, the control section drives the linear motor 651 to move the inspection head support 61 at a predetermined speed, and thereby to cause the A-side inspection head 4 and the B-side inspection head 5, which are fixed on the inspection head support 61, to pass over the boards S sucked and secured on the inspection suction tables placed in the A-side inspection position and the B-side inspection position, respectively (see FIG. 2). When the A-side inspection head 4 and the B-side inspection head 5 pass over the boards S, the control section controls the imaging device of the A-side inspection head 4 to capture an entire image of the A-side of the board S sucked and secured on the A-side inspection suction table placed in the A-side inspection position, and simultaneously controls the imaging device of the B-side inspection head 5 to capture an entire image of the B-side of the B-side inspection suction table placed in the B-side inspection position. That is, the board inspection apparatus 1 performs a scanning and imaging process in parallel on the A-side of a board S and the B-side of another board S. Then, the control section obtains inspection results based on image data concerning the captured images. For example, image data concerning predetermined patterns is pattern-patched with the image data concerning the captured images, thereby obtaining visual inspection results. In the present embodiment, the control section determines each of the A- and B-sides of a board S as either one of three grades: “passing”; “failing”; and “reinspection”. Note that when a board S is sucked and secured on a suction face placed in either the A-side inspection position or the B-side inspection position, the control section may control only an imaging device on the side where the board S is placed to perform an imaging operation and obtain an inspection result.

At step S5, the control section of the board inspection apparatus 1 ceases suction with an A-side inspection suction table placed in the board passing position. Specifically, the control section controls open/close operations of the switching valves of the air pressure control section provided in the first inspection stage 2 to cease supplying negative pressure to the A-side inspection suction table placed in the board passing position. In the example of FIG. 3, the A-side inspection suction table 22d is placed in the board passing position, and the control section causes the A-side inspection suction table 22d to cease suction.

Here, when one of two principal faces (specifically, B-side) of a board S is vacuum-sucked and secured on the suction face of the A-side inspection suction table placed in the board passing position, the other principal face (specifically, A-side) of the board S is in contact with a suction face of a B-side inspection suction table placed in the board passing position. When the control section ceases suction with the A-side inspection suction table placed in the board passing position, the suction on the B-side of the board S in the board passing position is released. Since the control section continues suction with the B-side inspection suction table placed in the board passing position, the A-side of the board S in the board passing position is vacuum-sucked and secured on the suction face of the B-side inspection suction table placed in the board passing position. Accordingly, the board S in the board passing position is passed from the A-side inspection suction table to the B-side inspection suction table, and the vacuum-sucked and secured principal face is switched from the B-side to the A-side.

Next, the control section of the board inspection apparatus 1 ceases suction with a B-side inspection suction table placed in the board ejection position (step S6). Specifically, the control section controls open/close operations of switching valves of an air pressure control section provided in the second inspection stage 3 to cease supplying negative pressure to the B-side inspection suction table placed in the board ejection position. In the example of FIG. 3, the B-side inspection suction table 32c is placed in the board ejection position, and the control section causes the B-side inspection suction table 32c to cease the suction.

Here, when one of two principal faces (specifically, A-side) of a board S is vacuum-sucked and secured on a suction face of the B-side inspection suction table placed in the board ejection position, the board S is placed in an opening of any one of the board cases 81a-81c of the board receiving section 8. When the control section ceases suction with the B-side inspection suction table placed in the board ejection position, the vacuum-suction on the principal face of the board S in the board ejection position is released, and the board S is ejected to the board receiving section 8. Note that for the sake of convenience, the operations at steps S4, S5, and S6 have been described as being performed consecutively, but they may be performed in parallel at the same time.

Next, the control section of the board inspection apparatus 1 controls all the air cylinders 23a-23d and 33a-33d to move in a contracted direction (step S7; the state as shown in FIG. 1). With this operation, the A-side inspection suction tables 22a-22d and the B-side inspection suction tables 32a-32d are all placed in the vicinity of a side surface of either the first rotary element 21 or the second rotary element 31.

Next, the control section of the board inspection apparatus 1 determines whether to terminate the inspection of boards S (step S8). When it is determined to terminate the inspection, the control section terminates the procedure of the flowchart in FIG. 6. On the other hand, when it is determined to continue the inspection, the control proceeds to step S9.

At step S9, in accordance with an inspection result, the control section of the board inspection apparatus 1 selects anyone of the board cases 81a-81c that is placed immediately below the second inspection stage 3, and controls the turn table 83 to turn such that the selected one of the board cases 81a-81c is placed immediately below the second inspection stage 3. Specifically, the control section selects one of the board cases 81a-81c based on an inspection result for a board S sucked and secured on a B-side inspection suction table placed at the right side of the second rotary shaft 34 shown in FIG. 1 (in FIG. 1, the B-side inspection suction table 32d), which is selected from among boards S sucked and secured on the B-side inspection suction tables 32a-32d. For example, when inspection results for both the A- and B-sides of a board S are “passing”, the control section determines the board S as passing an inspection, and selects the board case 81a for receiving boards Sok. Alternatively, when an inspection result for at least one of the A- and B-sides of a board S is “failing”, the control section determines the board S as failing an inspection, and selects the board case 81b for receiving boards Sng. Alternatively still, when inspection results for both the A- and B-sides of a board S are “reinspection” or when an inspection result for one of the A- and B-sides is “passing”, and an inspection result for the other is “reinspection”, the control section determines that a reinspection is required, and selects the board case 81c for receiving boards Svf. Note that step S9 may be performed immediately before performing step S6.

Next, the control section of the board inspection apparatus 1 controls the first rotary element 21 and the second rotary element 31 to turn 90 degrees in the directions “A” and “B”, respectively, as shown in FIG. 1 (step S10). Specifically, the control section drives the rotary drive motor 101 to turn the first rotary element 21 and the second rotary element 31 about the first rotary shaft 24 and the second rotary shaft 34, respectively. With this operation, the A-side inspection suction tables 22a-22d and the B-side inspection suction tables 32a-32d are all turned by 90 degrees.

Next, the control section of the board inspection apparatus 1 restarts suction with the A-side inspection suction table caused to cease suction at step S5, and also restarts suction with the B-side inspection suction table caused to cease suction at step S6 (step S11). With this operation, the control section causes all of the A-side inspection suction tables 22a-22d and the B-side inspection suction tables 32a-32d to perform a suction operation. Thereafter, the control returns to step S2, and the control section repeats the above-described processes.

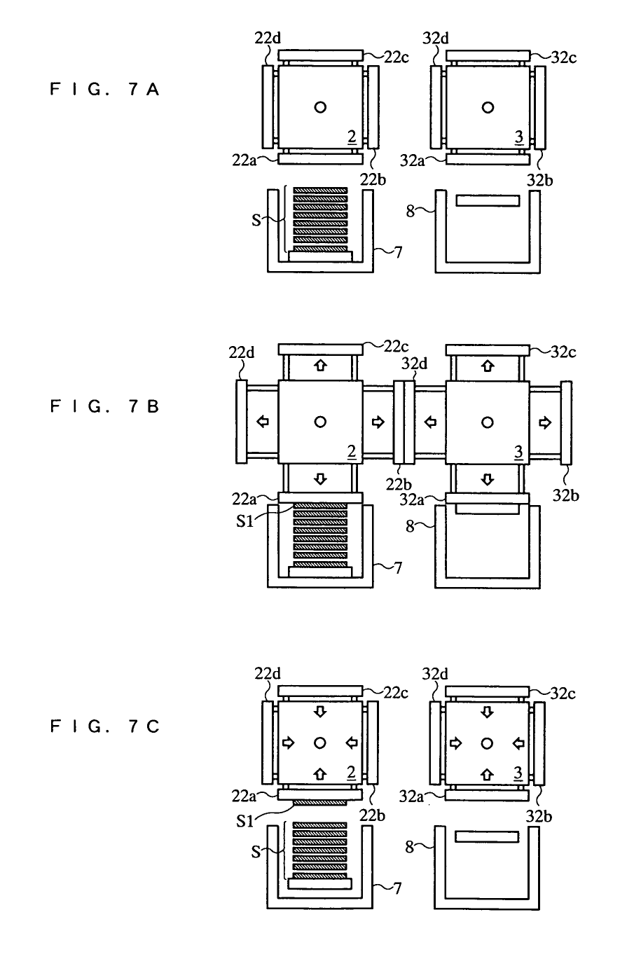

Next, referring to FIGS. 7A-13C, an operation performed by the board inspection apparatus 1 for moving boards S by repeating the procedure of the flowchart shown in FIG. 6 is described in detail. FIGS. 7A-13C are schematic views illustrating step-by-step how the board inspection apparatus 1 operates by repeating the procedure of the flowchart shown in FIG. 6. Note that outline arrows in the figures indicate operation directions of the A-side inspection suction tables 22a-22d and the B-side inspection suction tables 32a-32d when the air cylinders 23a-23d and 33a-33d perform extension/contraction operations, and solid arrows indicate rotary movements of the first rotary element 21 and the second rotary element 31.

FIG. 7A illustrates an initial state when uninspected boards S are supplied to the board inspection apparatus 1. In the board supply section 7, a plurality of boards S are accommodated and piled with their B-sides facing up. Also, among four A-side inspection suction tables 22a-22d of the first inspection stage 2, the A-side inspection suction table 22a is placed to face down. Also, among four B-side inspection suction tables 32a-32d of the second inspection stage 3, the B-side inspection suction table 32a is placed to face down. The control section of the board inspection apparatus 1 performs the above step S1 to start suction with all of the A-side inspection suction tables 22a-22d and the B-side inspection suction tables 32a-32d. For the sake of concrete illustration below, the plurality of boards S piled in the board supply section 7 are referred to as “boards S1, S2, S3, . . . ” in order from top to bottom.

Next, when the control section performs the above step S2 (first round), the A-side inspection suction tables 22a-22d and the B-side inspection suction tables 32a-32d are respectively moved away from the first rotary element 21 and the second rotary element 31. Then, the B-side of a board S1 placed on the top of the pile of boards S within the board supply section 7 is vacuum-sucked and secured onto the suction face of the A-side inspection suction table 22a placed in the board supply position (the state as shown in FIG. 7B).

Next, when the control section performs the above step S7 (first round), the A-side inspection suction tables 22a-22d and the B-side inspection suction tables 32a-32d are respectively moved to the vicinity of a side face of the first rotary element 21 and the vicinity of a side face of the second rotary element 31. Thereafter, the board S1 vacuum-sucked and secured on the suction face of the A-side inspection suction table 22a is picked up from the board supply section 7 (the state as shown in FIG. 7C).

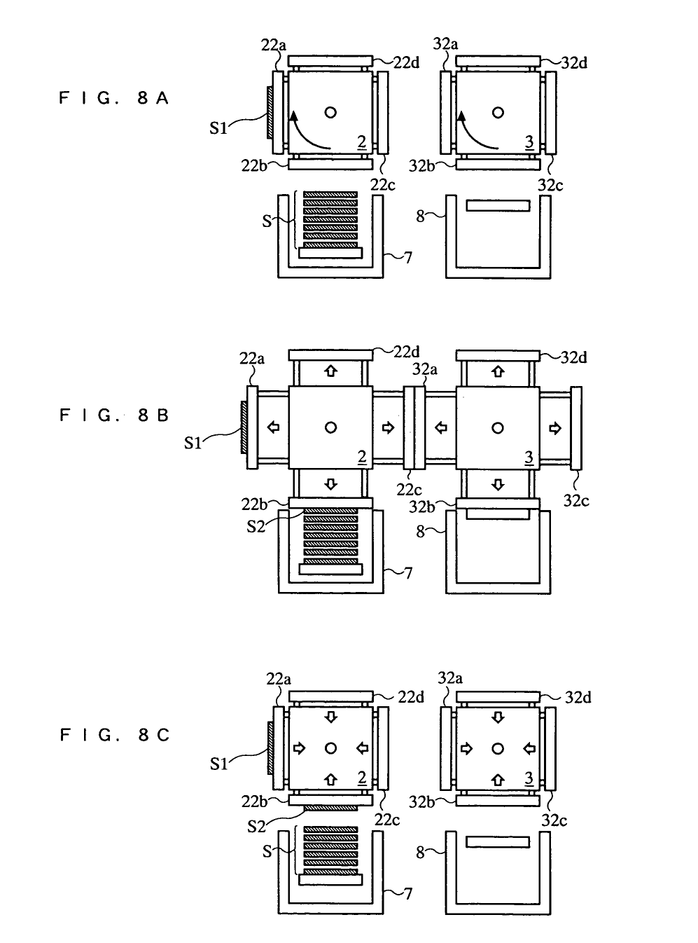

Next, when the control section performs the above step S10 (first round), the first rotary element 21 and the second rotary element 31 are turned by 90 degrees. Consequently, the A-side inspection suction tables 22a-22d, the B-side inspection suction tables 32a-32d, and the board S1 sucked and secured on the A-side inspection suction table 22a are all turned by 90 degrees (the state as shown in FIG. 8A). As shown in FIG. 8A, the first rotary element 21 and the second rotary element 31 are turned clockwise by 90 degrees.

Next, when the control section performs the above step S2 (second round), the A-side inspection suction tables 22a-22d and the B-side inspection suction tables 32a-32d are respectively moved away from the first rotary element 21 and the second rotary element 31. Then, the B-side of a board S2 placed on the top of the pile of boards S within the board supply section 7 is vacuum-sucked and secured onto the suction face of the A-side inspection suction table 22b placed in the board supply position (the state as shown in FIG. 8B).

Next, when the control section performs the above step S7 (second round), the A-side inspection suction tables 22a-22d and the B-side inspection suction tables 32a-32d are respectively moved to the vicinity of a side face of the first rotary element 21 and the vicinity of a side face of the second rotary element 31. Then, the board S2 vacuum-sucked and secured on the suction face of the A-side inspection suction table 22b is picked up from the board supply section 7 (the state as shown in FIG. 8C).

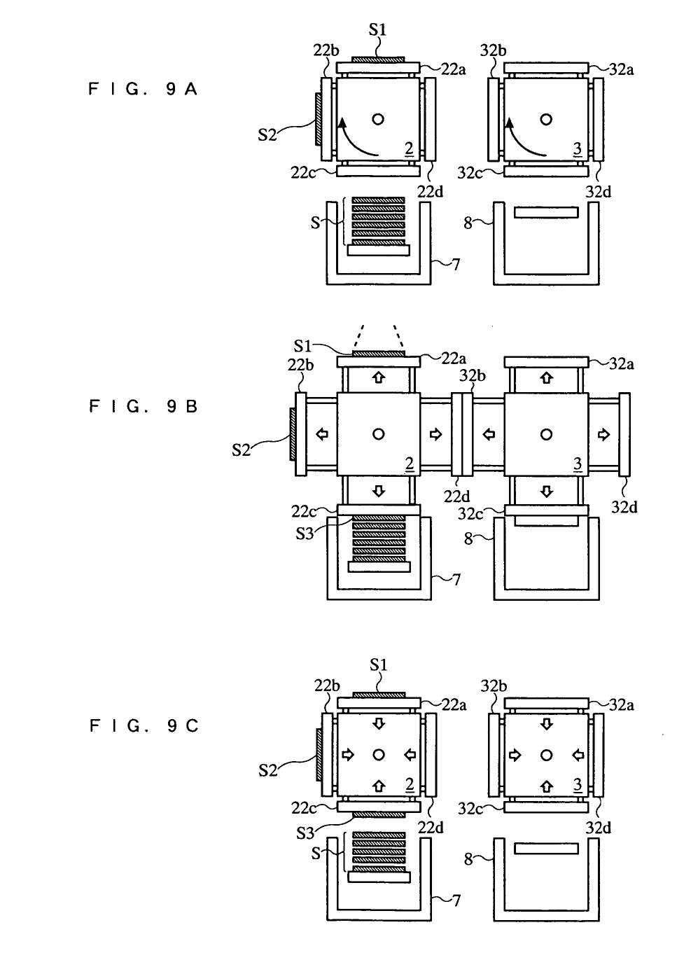

Next, when the control section performs the above step S10 (second round), the first rotary element 21 and the second rotary element 31 are turned by 90 degrees. Consequently, the A-side inspection suction tables 22a-22d, the B-side inspection suction tables 32a-32d, and the boards S1 and S2, which are sucked and secured on the A-side inspection suction tables 22a and 22b, respectively, are all turned by 90 degrees (the state as shown in FIG. 9A).

Next, when the control section performs the above step S2 (third round), the A-side inspection suction tables 22a-22d and the B-side inspection suction tables 32a-32d are respectively moved away from the first rotary element 21 and the second rotary element 31. Then, the B-side of a board S3 placed on the top of the pile of boards S within the board supply section 7 is vacuum-sucked and secured on the suction face of the A-side inspection suction table 22c placed in the board supply position. Further, when the control section performs the above step S4, the A-side of the board S1 sucked and secured on the A-side inspection suction table 22a in the A-side inspection position is captured as an image and inspected by the imaging device of the A-side inspection head 4 (the state as shown in FIG. 9B).

Next, when the control section performs the above step S7 (third round), the A-side inspection suction tables 22a-22d and the B-side inspection suction tables 32a-32d are respectively moved to the vicinity of a side face of the first rotary element 21 and the vicinity of a side face of the second rotary element 31. Then, the board S3 vacuum-sucked and secured on the suction face of the A-side inspection suction table 22c is picked up from the board supply section 7 (the state as shown in FIG. 9C).

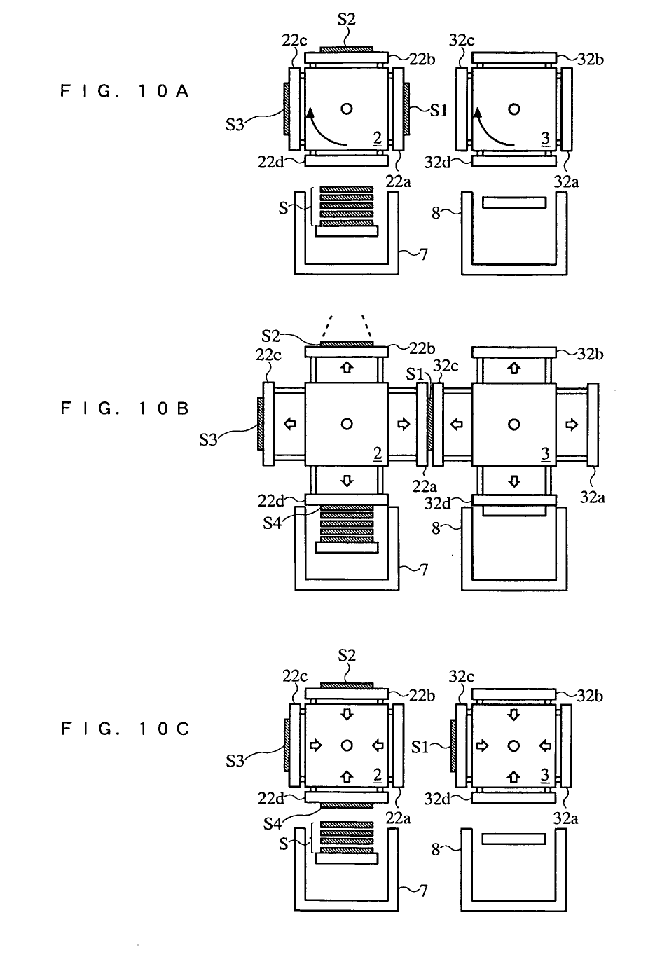

Next, when the control section performs the above step S10 (third round), the first rotary element 21 and the second rotary element 31 are turned by 90 degrees. Consequently, the A-side inspection suction tables 22a-22d, the B-side inspection suction tables 32a-32d, the boards S1-S3, which are sucked and secured on the A-side inspection suction tables 22a-22c, respectively, are all turned by 90 degrees (the state as shown in FIG. 10A).

Next, when the control section performs the above step S2 (fourth round), the A-side inspection suction tables 22a-22d and the B-side inspection suction tables 32a-32d are respectively moved away from the first rotary element 21 and the second rotary element 31. Then, the B-side of a board S4 placed on the top of the pile of boards S within the board supply section 7 is vacuum-sucked and secured onto the suction face of the A-side inspection suction table 22d placed in the board supply position. Also, the A-side of the board S1 vacuum-sucked and secured on the A-side inspection suction table 22a in the board passing position is brought into contact with the suction face of the B-side inspection suction table 32c in the board passing position. Further, when the control section performs the above step S4, the A-side of the board S2 sucked and secured on the A-side inspection suction table 22b in the A-side inspection position is captured as an image and inspected by the imaging device of the A-side inspection head 4 (the state as shown in FIG. 10B). Next, when the control section performs the above step S5, the vacuum-suction and securing of the board S1 on the A-side inspection suction table 22a in the board passing position is released, and the A-side of the board S1 is vacuum-sucked and secured onto the suction face of the B-side inspection suction table 32c.

Next, when the control section performs the above step S7 (fourth round), the A-side inspection suction tables 22a-22d and the B-side inspection suction tables 32a-32d are respectively moved to the vicinity of a side face of the first rotary element 21 and the vicinity of a side face of the second rotary element 31. Then, the board S4 vacuum-sucked and secured on the suction face of the A-side inspection suction table 22d is picked up from the board supply section 7. Also, the board S1 vacuum-sucked and secured on the suction face of the B-side inspection suction table 32c in the board passing position is passed from the first inspection stage 2 to the second inspection stage 3, and the vacuum-sucked and secured principal face of the board S1 is switched from the B-side to the A-side (the state as shown in FIG. 10C). Note that no board S remains on the suction face of the A-side inspection suction table 22a after the board S1 is passed therefrom.

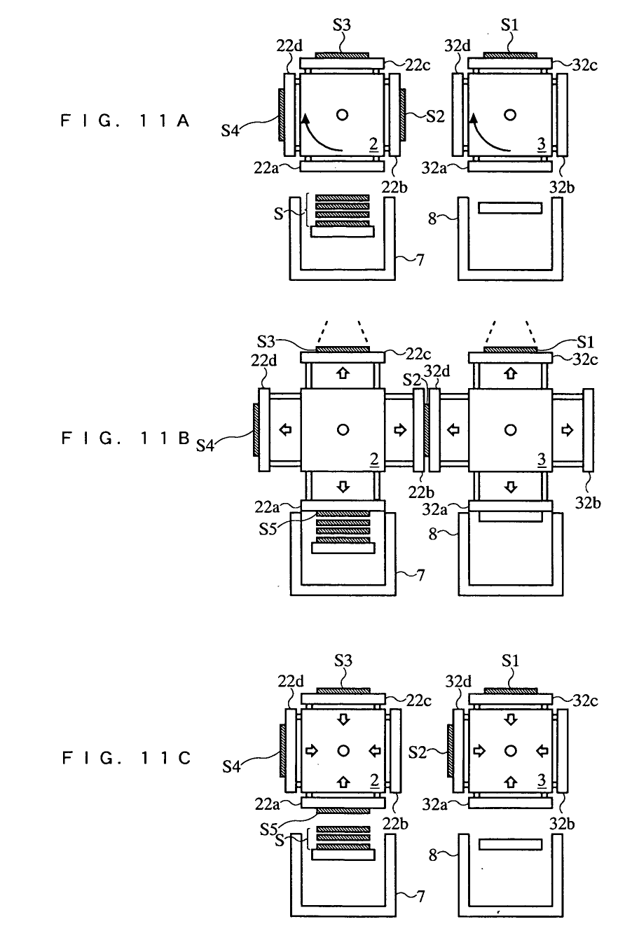

Next, when the control section performs the above step S10 (fourth round), the first rotary element 21 and the second rotary element 31 are turned by 90 degrees. Consequently, the A-side inspection suction tables 22a-22d, the B-side inspection suction tables 32a-32d, the boards S2-S4 sucked and secured on the A-side inspection suction tables 22b-22d, and the board S1 sucked and secured on the B-side inspection suction table 32c are all turned by 90 degrees (the state as shown in FIG. 11A). Then, when the control section performs the above step S11, the A-side inspection suction table 22a is caused to restart suction.

Next, when the control section performs the above step S2 (fifth round), the A-side inspection suction tables 22a-22d and the B-side inspection suction tables 32a-32d are respectively moved away from the first rotary element 21 and the second rotary element 31. Then, the B-side of a board S5 placed on the top of the pile of boards S within the board supply section 7 is vacuum-sucked and secured onto the suction face of the A-side inspection suction table 22a placed in the board supply position. Also, the A-side of the board S2 vacuum-sucked and secured on the A-side inspection suction table 22b in the board passing position is brought into contact with the suction face of the B-side inspection suction table 32d in the board passing position. Further, when the control section performs the above step S4, the A-side of the board S3 sucked and secured on the A-side inspection suction table 22c in the A-side inspection position is captured as an image and inspected by the imaging device of the A-side inspection head 4, in parallel with an operation performed by the imaging device of the B-side inspection head 5 for capturing, as an image, and inspecting the B-side of the board S1 sucked and secured on the B-side inspection suction table 32c in the B-side inspection position (the state as shown in FIG. 11B). Next, when the control section performs the above step S5, the vacuum-suction and securing of the board S2 by the A-side inspection suction table 22b in the board passing position is released, and the A-side of the board S2 is vacuum-sucked and secured onto the suction face of the B-side inspection suction table 32d.

Next, when the control section performs the above step S7 (fifth round), the A-side inspection suction tables 22a-22d and the B-side inspection suction tables 32a-32d are respectively moved to the vicinity of a side face of the first rotary element 21 and the vicinity of a side face of the second rotary element 31. Then, the board S5 vacuum-sucked and secured on the suction face of the A-side inspection suction table 22a is picked up from the board supply section 7. Also, the board S2 vacuum-sucked and secured on the suction face of the B-side inspection suction table 32d in the board passing position is passed from the first inspection stage 2 to the second inspection stage 3, and the vacuum-sucked and secured principal face of the board S2 is switched from the B-side to the A-side (the state as shown in FIG. 11C). Note that no board S remains on the suction face of the A-side inspection suction table 22b after the board S2 is passed therefrom.

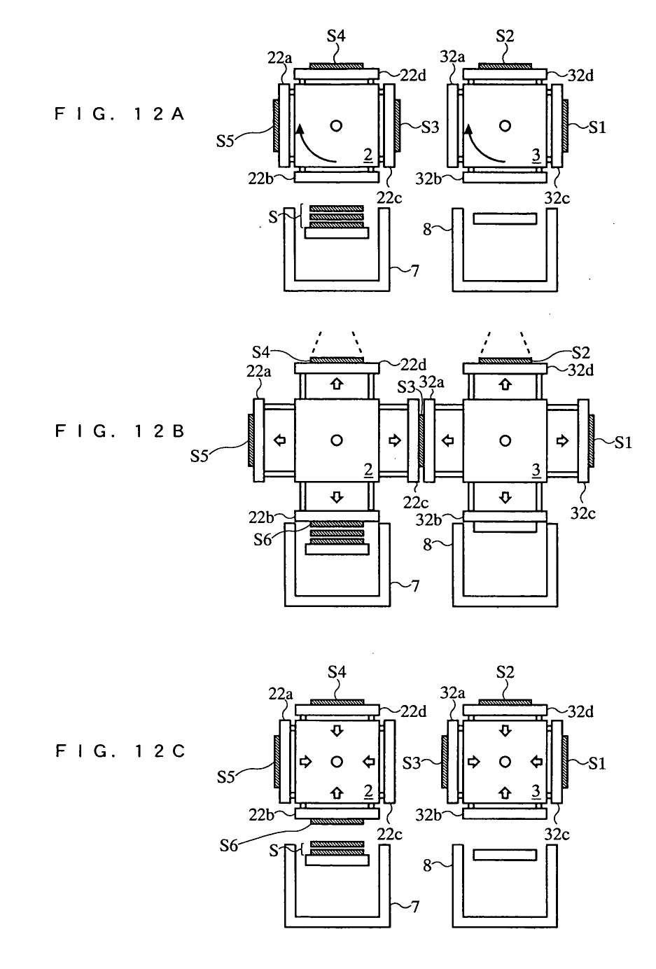

Next, when the control section performs the above step S10 (fifth round), the first rotary element 21 and the second rotary element 31 are turned by 90 degrees. Consequently, the A-side inspection suction tables 22a-22d, the B-side inspection suction tables 32a-32d, the boards S3-S5 sucked and secured on the A-side inspection suction tables 22a, 22c, and 22d, and the boards S1 and S2 sucked and secured on the B-side inspection suction tables 32c and 32d are all turned by 90 degrees (the state as shown in FIG. 12A). Thereafter, when the control section performs the above step S11, the A-side inspection suction table 22b is caused restart suction.

Next, when the control section performs the above step S2 (sixth round), the A-side inspection suction tables 22a-22d and the B-side inspection suction tables 32a-32d are respectively moved away from the first rotary element 21 and the second rotary element 31. Then, the B-side of a board S6 placed on the top of the pile of boards S within the board supply section 7 is vacuum-sucked and secured on the suction face of the A-side inspection suction table 22a placed in the board supply position. Also, the A-side of the board S3 vacuum-sucked and secured on the A-side inspection suction table 22c in the board passing position is brought into contact with the suction face of the B-side inspection suction table 32a in the board passing position. Further, when the control section performs the above step S4, the A-side of the board S4 sucked and secured on the A-side inspection suction table 22d in the A-side inspection position is captured as an image and inspected by the imaging device of the A-side inspection head 4, in parallel with an operation performed by the imaging device of the B-side inspection head 5 for capturing, as an image, and inspecting the B-side of the board S2 sucked and secured on the B-side inspection suction table 32d in the B-side inspection position (the state as shown in FIG. 12B). Next, when the control section performs the above step S5, the vacuum-suction and securing of the board S3 by the A-side inspection suction table 22c in the board passing position is released, and the A-side of the board S3 is vacuum-sucked and secured onto the suction face of the B-side inspection suction table 32a.

Next, when the control section performs the above step S7 (sixth round), the A-side inspection suction tables 22a-22d and the B-side inspection suction tables 32a-32d are respectively moved to the vicinity of a side face of the first rotary element 21 and the vicinity of a side face of the second rotary element 31. Then, the board S6 vacuum-sucked and secured on the suction face of the A-side inspection suction table 22b is picked up from the board supply section 7. Also, the board S3 vacuum-sucked and secured on the suction face of the B-side inspection suction table 32a in the board passing position is passed from the first inspection stage 2 to the second inspection stage 3, and the vacuum-sucked and secured principal face of the board S3 is switched from the B-side to the A-side (the state as shown in FIG. 12C). Note that no board S remains on the suction face of the A-side inspection suction table 22c after the board S3 is passed therefrom. Thereafter, when the control section performs the above step S9, one of the board cases of the board receiving section 8 is selected based on an A-side inspection result (see FIG. 9B) and a B-side inspection result (see FIG. 11B) for the board S1, and the turn table 83 is turned.

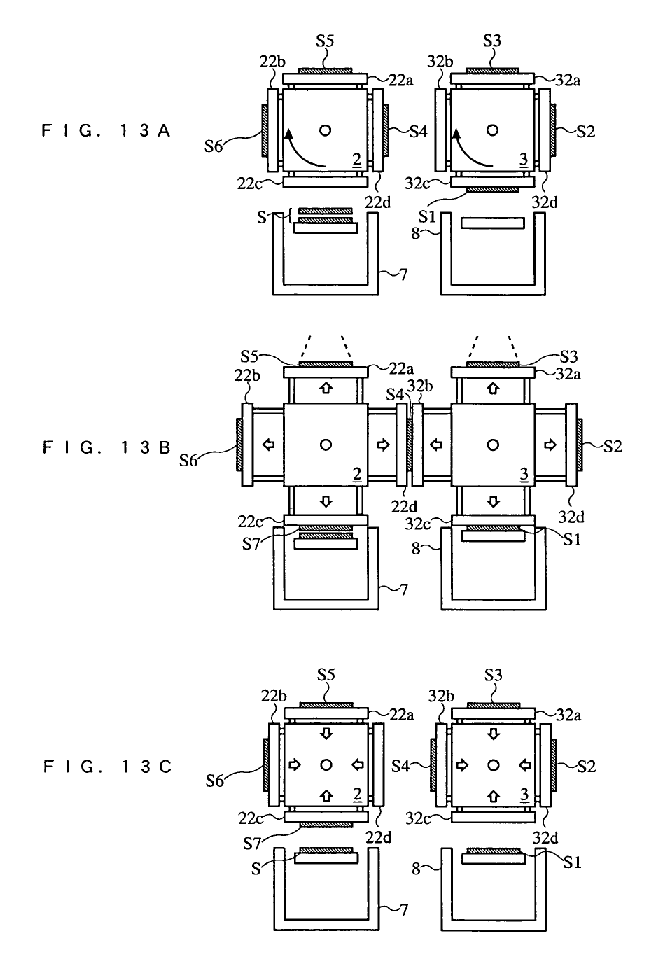

Next, when the control section performs the above step S10 (sixth round), the first rotary element 21 and the second rotary element 31 are turned by 90 degrees. Consequently, the A-side inspection suction tables 22a-22d, the B-side inspection suction tables 32a-32d, the boards S4-S6 sucked and secured on the A-side inspection suction tables 22a, 22b, and 22d, and the boards S1-S3 sucked and secured on the B-side inspection suction tables 32a, 32c and 32d are all turned by 90 degrees (the state as shown in FIG. 13A). Thereafter, when the control section performs the above step S11, the A-side inspection suction table 22c is caused to restart suction.

Next, when the control section performs the above step S2 (seventh round), the A-side inspection suction tables 22a-22d and the B-side inspection suction tables 32a-32d are respectively moved away from the first rotary element 21 and the second rotary element 31. Then, the B-side of a board S7 placed on the top of the pile of boards S within the board supply section 7 is vacuum-sucked and secured on the suction face of the A-side inspection suction table 22c placed in the board supply position. Also, the A-side of the board S4 vacuum-sucked and secured on the A-side inspection suction table 22d in the board passing position is brought into contact with the suction face of the B-side inspection suction table 32b in the board passing position. Further, the board S1 vacuum-sucked and secured on the B-side inspection suction table 32c in the board ejection position is placed in an opening of the selected one of the board cases of the board receiving section 8. Also, when the control section performs the above step S4, the A-side of the board S5 sucked and secured on the A-side inspection suction table 22a in the A-side inspection position is captured as an image and inspected by the imaging device of the A-side inspection head 4, in parallel with an operation performed by the imaging device of the B-side inspection head 5 for capturing, as an image, and inspecting the B-side of the board S3 sucked and secured on B-side inspection suction table 32a in the B-side inspection position (the state as shown in FIG. 13B). Next, when the control section performs the above step S5, the vacuum-suction and securing of the board S4 by the A-side inspection suction table 22d in the board passing position is released, and the A-side of the board S4 is vacuum-sucked and secured onto the B-side inspection suction table 32b. Thereafter, when the control section performs the above step S6, the vacuum-suction and securing of the board S1 by the B-side inspection suction table 32c in the board ejection position is released.

Next, when the control section performs the above step S7 (seventh round), the A-side inspection suction tables 22a-22d and the B-side inspection suction tables 32a-32d are respectively moved to the vicinity of a side face of the first rotary element 21 and the vicinity of a side face of the second rotary element 31. Then, the board S7 vacuum-sucked and secured on the suction face of the A-side inspection suction table 22c is picked up from the board supply section 7. Also, the board S4 vacuum-sucked and secured on the suction face of the B-side inspection suction table 32b in the board passing position is passed from the first inspection stage 2 to the second inspection stage 3, and the vacuum-sucked and secured principal face of the board S4 is switched from the B-side to the A-side. Then, the board S1 released from the vacuum-suction and securing by the B-side inspection suction table 32c is ejected to the selected one of the board cases of the board receiving section 8 (the state as shown in FIG. 13C). The above-described operations are repeatedly performed, so that the boards S piled within the board supply section 7 of the board inspection apparatus 1 are visually inspected with respect to their opposite sides, and sequentially ejected to the board receiving section 8.

As described above, in the board inspection apparatus 1, different processes are performed on boards S sucked and secured on the A-side inspection suction tables 22a-22d and the B-side inspection suction tables 32a-32-d, and these processes are simultaneously performed in parallel with each other. Specifically, the board inspection apparatus 1 repeats the procedure of the flowchart shown in FIG. 6, thereby performing in parallel operations in accordance with table positions: an operation for sucking a board S with an A-side inspection suction table; an operation for capturing an image of the A-side of a board S; an operation for turning over a board S by passing the board S from the first inspection stage 2 to the second inspection stage 3; an operation for capturing an image of the B-side of a board S; and an operation for ejecting aboard S from the B-side inspection suction table 32. Accordingly, the board inspection apparatus 1 performs in parallel a series of processes for inspecting opposite sides of boards S, whereby it is possible to inspect in parallel the opposite sides of the boards S, while ensuring efficient throughput. Also, even if the boards S are printed circuit boards composed of a fragile material, a principal face of each board S is supported by a table in contact therewith, and therefore the board S can be reliably secured. Further, the board S is not covered by any element except in a portion in contact with the table, and therefore any portion of the board S can be captured as an image by an imaging device.

Note that although the foregoing has illustrated an example where boards S are vacuum-sucked and secured onto the A-side inspection suction tables and the B-side inspection suction tables, another method may be used for holding the boards S on the A-side inspection suction tables and the B-side inspection suction table. For example, electrostatic suction may be used for holding the boards S on the A-side inspection suction tables and the B-side inspection suction tables. Also, the mechanisms for changing the distance between the A-side inspection suction tables and the first rotary element 21 and the mechanisms for changing the distance between the B-side inspection suction tables and the second rotary element 31 do not have to be the air cylinders. For example, lifting mechanisms using an electrical driving source can be used. Although the above embodiment has illustrated an example where the A-side inspection suction tables and the B-side inspection suction tables are all simultaneously caused to perform a suction operation, the tables may be caused to perform a suction operation only when necessary, e.g., at the beginning of a series of processes. Also, the air cylinders may be configured so as not to be extracted/contracted where such operations are not necessary (for example, the air cylinders 23b and 33d in FIG. 3).

Also, the foregoing has illustrated an example where, when all the air cylinders 23a-23d and 33a-33d are extended, an A-side inspection suction table and a B-side inspection suction table (specifically, the A-side inspection suction table 22b and the B-side inspection suction table 32d shown in FIG. 3) are placed in none of the following positions: the A-side inspection position; the B-side inspection position; the board supply position; the board passing position; and the board ejection position. In the above-mentioned example, no process is performed on boards S sucked and secured on such A-side inspection suction table and B-side inspection suction table. However, such boards Scan be subjected to an additional process on both the A- and B-sides thereof. Even if the additional process is performed on the A- and B-sides of the boards S, the board inspection apparatus 1 is able to perform in parallel a series of processes for inspecting opposite sides of boards S, and therefore the series of processes can be performed without increasing processing time.

Also, the foregoing has illustrated an example where the A-side inspection head 4 and the B-side inspection head 5 are fixed on one inspection head support 61, and a scanning and imaging process is performed on boards S in one scanning direction (the direction indicated by arrows “C” in FIG. 2) by moving the inspection head support 61 in one direction. This allows one driving source (linear motor 651) to be applied to all necessary scanning and imaging processes. However, the A-side inspection head 4 and the B-side inspection head 5 may be configured so as to movable along the inspection head support 61 in a direction perpendicular to the above moving direction (i.e., a horizontal direction perpendicular to the direction indicated by arrows “C” in FIG. 2). In such a case, it is possible to increase an area where the A-side inspection head 4 and the B-side inspection head 5 can be used for a scanning and imaging process.

Note that in the board inspection apparatus 1, each of the first inspection stage 2 and the second inspection stage 3 has four inspection suction tables, but the present invention is not limited to this. The present invention is applicable to a case where each of the two inspection stages has more than or less than four inspection suction stages.

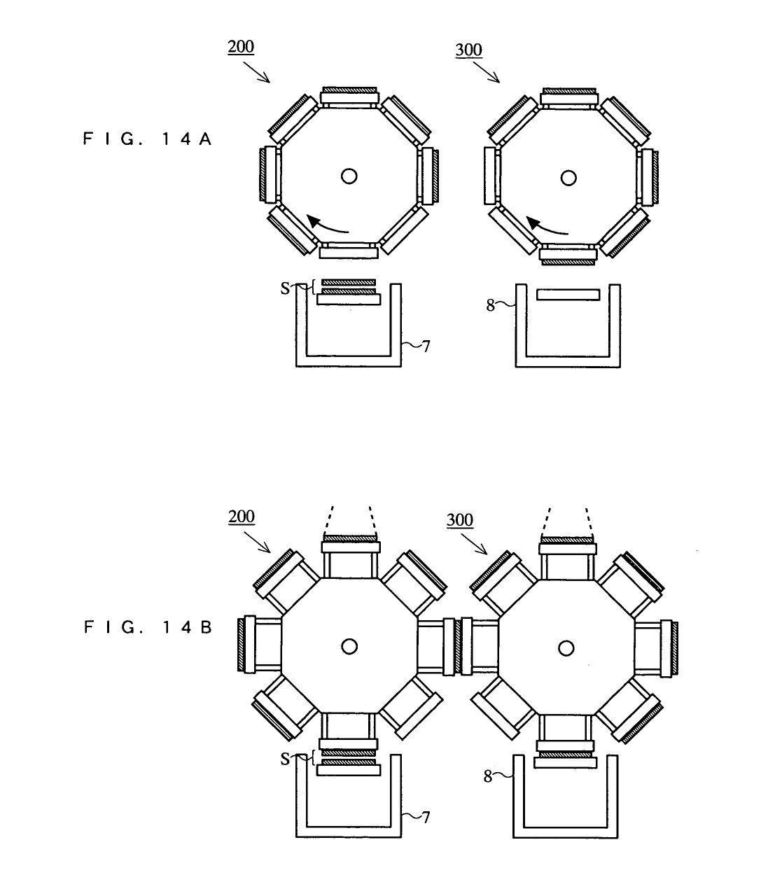

FIGS. 14A and 14B illustrate an example where a first inspection stage 200 and a second inspection stage 300 each include eight inspection suction tables. Specifically, in FIG. 14A, air cylinders for supporting the inspection suction stages are each in a contracted state, and in FIG. 14B, the air cylinders for supporting the inspection suction stages are each in an extended state. Also, in FIGS. 14A and 14B, boards S to be inspected are shown in hatching.

As shown in FIGS. 14A and 14B, each of the first inspection stage 200 and the second inspection stage 300 includes a rotary element in the form of a regular octagonal prism. The first inspection stage 200 and the second inspection stage 300 are configured so as to be rotatable in units of 45 degrees in a direction indicated by an arrow in FIG. 14A about a rotary shaft passing through centers of two bases of the regular octagonal prism. An inspection suction table is provided on an air cylinder above each of eight faces of the regular octagonal prism-shaped rotary element. When all air cylinders are in a contracted state, each inspection suction table is placed near the regular octagonal prism-shaped rotary element (the state as shown in FIG. 14A), and when all air cylinders are in an extended state, each inspection suction table is placed away from the regular octagonal prism-shaped rotary element (the state as shown in FIG. 14B).

When all air cylinders are in an extended state, one of the inspection suction tables provided in the first inspection stage 200 (e.g., a table facing down) is placed in the board supply position to suck and secure a board S placed on the top of the pile of boards S within the board supply section 7. Also, another one of the inspection suction tables provided in the first inspection stage 200 (e.g., a table facing up) is placed in the A-side inspection position to perform a scanning and imaging operation on the A-side of a board S sucked and secured on the inspection suction table. Further, still another one of the inspection suction tables provided in the first inspection stage 200 (e.g., a table facing right) is placed in the board passing position, and the A-side of a board S sucked and secured on the inspection suction table is brought into contact with an inspection suction table of the second inspection stage 300.

When all air cylinders are in an extended state, one of the inspection suction tables provided in the second inspection stage 300 (e.g., a table facing left) is placed in the board passing position, and a board S is passed from the first inspection stage 200. Also, another one of the inspection suction tables provided in the second inspection stage 300 (e.g., a table facing up) is placed in the B-side inspection position to perform a scanning and imaging operation on the B-side of a board S sucked and secured on the inspection suction table. Further, still another one of the inspection suction tables provided in the second inspection stage 300 (e.g., a table facing down) is placed in the board ejection position, and a board S is ejected to the board receiving section 8.

As described above, even in the case of using two inspection stages each including eight inspection suction tables, different processes are performed on boards S sucked and secured on the inspection suction tables, and these processes can be performed in parallel with each other at the same time.

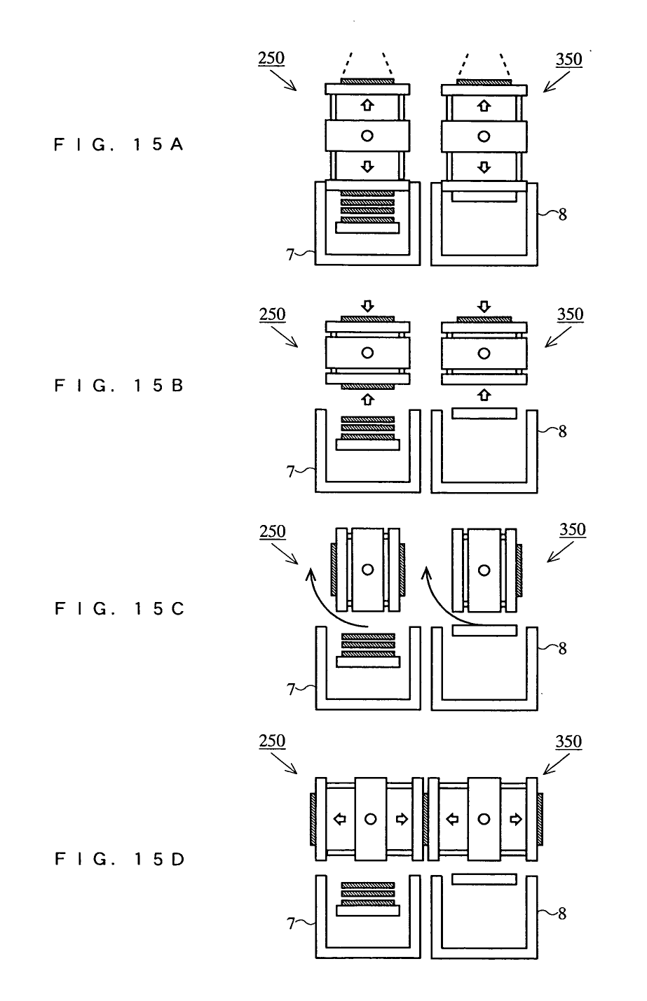

FIGS. 15A-15D illustrate an example where a first inspection stage 250 and a second inspection stage 350 each include two inspection suction tables. Specifically, in FIG. 15A, air cylinders for supporting the inspection suction stages placed in a vertical direction are in an extended state. In FIG. 15B, the air cylinders for supporting the inspection suction stages placed in a vertical direction are in a contracted state. In FIG. 15C, the air cylinders for supporting the inspection suction stages placed in a horizontal direction are in a contracted state. In FIG. 15D, the air cylinders for supporting the inspection suction stages placed in a horizontal direction are in an extended state. Also, in FIGS. 15A-15D, boards S to be inspected are shown in hatching.

As shown in FIGS. 15A-15D, each of the first inspection stage 250 and the second inspection stage 350 includes a rotary element which rotates about a corresponding rotary shaft. The first inspection stage 250 and the second inspection stage 350 are each configured so as to be rotatable in units of 90 degrees in a direction indicated by an arrow in FIG. 15C. The two inspection suction tables are provided in parallel on air cylinders positioned on opposite sides of the rotary element. When all the air cylinders are in a contracted state, each inspection suction table is placed near the rotary element (the state as shown in FIGS. 15B and 15C), and when all the air cylinders are in an extended state, each inspection suction table is placed away from the rotary element (the state as shown in FIGS. 15A and 15D).

When the air cylinders of the inspection suction stages positioned in a vertical direction are in an extended state (the state as shown in FIG. 15A), one of the inspection suction tables provided in the first inspection stage 250 (e.g., a table facing down) is placed in the board supply position to suck and secure a board S placed on the top of the pile of boards S within the board supply section 7. Also, the other of the inspection suction tables provided in the first inspection stage 250 (e.g., a table facing up) is placed in the A-side inspection position, a scanning and imaging process is performed on the A-side of a board S sucked and secured on the inspection suction table. Also, one of the inspection suction tables provided in the second inspection stage 350 (e.g., a table facing up) is placed in the B-side inspection position, a scanning and imaging process is performed on the B-side of a board S sucked and secured on the inspection suction table. Also, the other of the inspection suction tables provided in the second inspection stage 350 (e.g., a table facing down) is placed in the board ejection position, aboard S is ejected to the board receiving section 8.

When the air cylinders of the inspection suction stages positioned in a horizontal direction are in an extended state (the state as shown in FIG. 15D), one of the inspection suction tables provided in the first inspection stage 250 (e.g., a table facing right) is placed in the board passing position, and the A-side of a board S sucked and secured on the inspection suction table is brought into contact with a suction face of an inspection suction table of the second inspection stage 350. Also, one of the inspection suction tables provided in the second inspection stage 350 (e.g., a table facing left) is placed in the board passing position, a board S is passed from the first inspection stage 250.

As described above, even in the case of using two inspection stages each including two inspection suction tables, different processes are performed on boards S sucked and secured on the inspection suction tables, and these processes can be performed in parallel with each other at the same time.

Also, first and second inspection stages each may have a rotary element in the form of a regular triangular prism. In this case, the first and second inspection stages are configured so as to be rotatable in units of 120 degrees about a rotary shaft passing through centers of two bases of the regular triangular prism. An inspection suction table is provided on an air cylinder above each of three faces of the regular triangular prism-shaped rotary element. Any one inspection suction table of the first inspection stage is positioned so as to be opposed to one inspection suction table of the second inspection stage. With this configuration, an effect similar to that achieved by the present invention can be achieved.

While the invention has been described in detail, the foregoing description is in all aspects illustrative and not restrictive. It is understood that numerous other modifications and variations can be devised without departing from the scope of the invention.

1. A board inspection apparatus for capturing, as an image, and inspecting opposite sides of a board, the apparatus comprising:
a first inspection stage including a plurality of first board holding faces provided about a first rotary shaft, the plurality of first board holding faces each being brought into contact with a first principal face of the board to hold the board;
a second inspection stage provided next to the first inspection stage and including a plurality of second board holding faces provided about a second rotary shaft, the plurality of second board holding faces each being brought into contact with a second principal face of the board to hold the board;
a rotary drive section for changing directions of the plurality of first board holding faces and the plurality of second board holding faces by turning the first inspection stage about the first rotary shaft and turning the second inspection stage about the second rotary shaft;
an imaging section for simultaneously capturing images of principal faces of boards held by a parallel set consisting of a first board holding face and a second board holding face positioned in parallel therewith;
a board supply section for supplying a board to a first board holding face different from the first board holding face in the parallel set; and
a board ejection section for ejecting a board held by a board holding face different from the second board holding face in the parallel set.

2. The board inspection apparatus according to claim 1, further comprising a control section for controlling the plurality of first board holding faces or the plurality of second board holding faces so as to hold and release the board, wherein
the first inspection stage includes a first board holding face drive section for moving the plurality of first board holding faces to change their distances from the first rotary shaft,
the second inspection stage includes a second board holding face drive section for moving the plurality of second board holding faces to change their distances from the second rotary shaft,
the first board holding face drive section and the second board holding face drive section cause an opposing set consisting of a first board holding face and a second board holding face opposed thereto, to move away from the first rotary shaft and the second rotary shaft, respectively, such that a second principal face of a board held by the first board holding face in the opposing set is brought into contact with the second board holding face in the opposing set, and
the control section controls the opposing set of the first board holding face and the second board opposed thereto, such that a board held by the first board holding face in the opposing set is released therefrom, and held by the second board holding face in the opposing set.

3. The board inspection apparatus according to claim 1, wherein the imaging section includes:
a first imaging device for capturing an image of a second principal face of a board held by the first board holding face in the parallel set;
a second imaging device for capturing an image of a first principal face of a board held by the second board holding face in the parallel set;
a supporting element for supporting the first imaging device and the second imaging device; and
a linear drive section for moving the supporting element in a direction parallel to the parallel set consisting of the first board holding face and the second board holding face positioned in parallel therewith.

4. The board inspection apparatus according to claim 1, wherein
the first inspection stage has four first board holding faces provided in four directions around the first rotary shaft, and
the second inspection stage has four second board holding faces provided in four directions around the second rotary shaft.

5. The board inspection apparatus according to claim 4, wherein
the first rotary shaft and the second rotary shaft are horizontally positioned in parallel with each other,
the rotary drive section turns the first inspection stage and the second inspection stage such that at least one of the four first board holding faces and at least one of the four second board holding faces are opposed to each other,
the imaging section simultaneously captures images of principal faces of boards held by a parallel set consisting of a first board holding face and a second board holding face, which are positioned in parallel with each other on top sides of the first inspection stage and the second inspection stage, respectively,
the board supply section supplies a board to a first board holding face positioned on a bottom side of the first inspection stage,
the board ejection section ejects a board held by a second board holding face positioned on a bottom side of the second inspection stage, and
a board is passed from a first board holding face to a second board holding face opposed thereto.

6. The board inspection apparatus according to claim 5, further comprising a control section for controlling the four first board holding faces or the four second board holding faces so as to hold and release the board, wherein
the first inspection stage includes a first board holding face drive section for moving the four first board holding faces so as to change their distances from the first rotary shaft,
the second inspection stage includes a second board holding face drive section for moving the four second board holding faces so as to change their distance from the second rotary shaft,
the first board holding face drive section and the second board holding face drive section cause an opposing set consisting of a first board holding face and a second board holding face opposed thereto, to move away from the first rotary shaft and the second rotary shaft, respectively, such that a second principal face of a board held by the first board holding face in the opposing set is brought into contact with the second board holding face in the opposing set, and
the control section controls the opposing set of the first board holding face and the second board opposed thereto, such that a board held by the first board holding face in the opposing set is released from the first board holding face in the opposing set, and passed to and held by the second board holding face in the opposing set.

7. The board inspection apparatus according to claim 5, further comprising contact portions fixed in an imaging space of the imaging section, wherein
the first inspection stage includes a first board holding face drive section for moving the four first board holding faces to change their distances from the first rotary shaft,
the second inspection stage includes a second board holding face drive section for moving the four second board holding faces to change their distances from the second rotary shaft, and
the first board holding face drive section and the second board holding face drive section cause a parallel set consisting of a first board holding face and a second board holding face positioned in parallel therewith, to move away from the first rotary shaft and the second rotary shaft, respectively, such that the parallel set of the first board holding face and the second board holding face positioned in parallel therewith are positioned so as to be in contact with their respective contact portions.

8. The board inspection apparatus according to claim 5, wherein
the board ejection section includes:
a plurality of board cases for receiving an ejected board; and
a turn table having a rotary flat face turning about a predetermined perpendicular axis, the rotary flat face having the plurality of board cases mounted thereon, and
the board ejection section turns the turn table such that one of the plurality of board cases is positioned immediately below the second board holding face positioned on the bottom side of the second inspection stage in accordance with the board held by the second board holding face positioned on the bottom side of the second inspection stage.

9. Aboard inspection method for capturing, as an image, and inspecting opposite sides of a board, the method comprising:
a board supply step for supplying the board to a first inspection stage including a plurality of first board holding faces provided about a first rotary shaft, at least one of the plurality of first board holding faces being brought into contact with a first principal face of the board to hold the board;
an imaging step for simultaneously capturing images of principal faces of boards held by a parallel set consisting of a first board holding face and a second board holding face positioned in parallel therewith;
a board ejection step for ejecting a board held by at least one of a plurality of second board holding faces from a second inspection stage provided next to the first inspection stage and including the plurality of second board holding faces provided about a second rotary shaft; and
a turning step for changing directions of the plurality of first board holding faces and the plurality of second board holding faces by turning the first inspection stage about the first rotary shaft and turning the second inspection stage about the second rotary shaft.

10. The board inspection method according to claim 9, further comprising a board passing step for passing a board by a first board holding face to a second board holding face opposed to the first board holding face, so as to bring the second board holding face into contact with a second principal face of the board, and thereby to cause the second board holding face to hold the board, wherein the board supply step, the imaging step, the board ejection step, and the board passing step are simultaneously performed.
